(19) United States
(12) Patent Application Publication
(10) Pub. No.: US 2021/0334068 A1
(43) Pub. Date: Oct. 28, 2021

(54) SELECTABLE OPTIONS BASED ON AUDIO CONTENT

(71) Applicant: QUALCOMM Incorporated, San Diego, CA (US)

(72) Inventor: Karthik RANGARAJU, Hyderbad (IN)

(21) Appl. No.: 16/894,957

(22) Filed: Jun. 8, 2020

(30) Foreign Application Priority Data
Apr. 25, 2020 (IN) 202041017758

(51) Int. Cl. G06F 3/16; G10L 15/18; G06F 3/0484

(52) U.S. Cl. CPC G06F 3/167; G10L 2015/088; G06F 3/04842; G10L 15/1822

(57) ABSTRACT

A device to automatically propose actions based on audio content includes a memory configured to store instructions corresponding to an action recommendation unit. The device also includes one or more processors coupled to the memory and configured to receive audio data corresponding to the audio content. The one or more processors are also configured to execute the action recommendation unit to process the audio data to identify one or more portions of the audio data that are associated with an action and to present a user-selectable option to perform the action.

### I. CROSS-REFERENCE TO RELATED APPLICATIONS

The present application claims priority from India Provisional Patent Application No. 202041017758, filed Apr. 25, 2020, entitled “SELECTABLE OPTIONS BASED ON AUDIO CONTENT,” which is incorporated herein by reference in its entirety.

### II. FIELD

The present disclosure is generally related to presenting options to a user of an electronic device based on audio content.

### III. Description of Related Art

Advances in technology have resulted in smaller and more powerful computing devices. For example, a variety of portable personal computing devices, including wireless telephones such as mobile and smart phones, tablets, and laptop computers are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such portable personal computing devices may provide one or more applications to assist users with keeping track of information, such as a calendar, contact list, or note-taking application. Although such applications provide an enhanced user experience as compared to writing notes into a paper notebook, using such applications during a face-to-face conversation or telephone call is distracting to the user and interrupts the flow of the conversation, while using the applications after a face-to-face conversation or telephone call increases the likelihood that one or more items that the user wanted to remember will be forgotten before it can be entered by the user into the application.

### IV. SUMMARY

According to one implementation of the techniques disclosed herein, a device to automatically propose actions based on audio content includes a memory configured to store instructions corresponding to an action recommendation unit. The device also includes one or more processors coupled to the memory and configured to receive audio data corresponding to the audio content. The one or more processors are also configured to execute the action recommendation unit to process the audio data to identify one or more portions of the audio data that are associated with an action and to present a user-selectable option to perform the action.

According to another implementation of the techniques disclosed herein, a method of automatically proposing actions based on audio content includes receiving, at one or more processors, audio data corresponding to the audio content. The method also includes processing the audio data to identify one or more portions of the audio data that are associated with an action. The method further includes presenting a user-selectable option to perform the action.

According to another implementation of the techniques disclosed herein, a non-transitory computer readable medium stores instructions for automatically proposing actions based on audio content. The instructions, when executed by one or more processors, cause the one or more processors to receive audio data at one or more processors. The instructions, when executed by the one or more processors, also cause the one or more processors to process the audio data to identify one or more portions of the audio data that are associated with an action. The instructions, when executed by the one or more processors, also cause the one or more processors to present a user-selectable option to perform the action.

According to another implementation of the techniques disclosed herein, an apparatus includes means for receiving audio data at one or more processors. The apparatus also includes means for processing the audio data to identify one or more portions of the audio data that are associated with an action. The apparatus further includes means for presenting a user-selectable option to perform the action.

Other implementations, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is an illustrative example of a system that includes a device operable to present a selectable option based on audio content, in accordance with some examples of the present disclosure.

FIG. 2 is an illustrative example of components that can be included in the device of FIG. 1, in accordance with some examples of the present disclosure.

FIG. 3 is an illustrative example of a system that includes the device of FIG. 1 operable to present a selectable option based on audio content of a phone call, in accordance with some examples of the present disclosure.

FIG. 4 is an illustrative example of functions that may be performed by the device of FIG. 1, in accordance with some examples of the present disclosure.

FIG. 5 is an illustrative example of various lists of selectable options that may be presented by the device of FIG. 1 based on detection of various events, in accordance with some examples of the present disclosure.

FIG. 6 is an illustrative example of a virtual reality or augmented reality headset operable to present a selectable option based on audio content, in accordance with some examples of the present disclosure.

FIG. 7 is an illustrative example of a vehicle operable to present a selectable option based on audio content, in accordance with some examples of the present disclosure.

FIG. 8 is an illustrative example of a voice-controlled speaker system operable to present a selectable option based on audio content, in accordance with some examples of the present disclosure.

FIG. 9 is an illustrative example of a wearable electronic device operable to present a selectable option based on audio content, in accordance with some examples of the present disclosure.

FIG. 10 is a diagram of another particular implementation of a system including a device operable to present a selectable option based on audio content, in accordance with some examples of the present disclosure

FIG. 11 is a flowchart of a method automatically proposing actions based on audio content, in accordance with some examples of the present disclosure.

FIG. 12 is a block diagram of a particular illustrative example of a device that is operable to perform the techniques described with reference to FIGS. 1-11, in accordance with some examples of the present disclosure.

### VI. DETAILED DESCRIPTION

Although electronic devices conventionally provide applications such as a calendar, contact database, or note-taking application, using such applications during a face-to-face conversation or telephone call is distracting to the user and interrupts the flow of the conversation. However, if the user waits until after the face-to-face conversation or telephone call is over to enter information into one or more such applications, there is a possibility that the user will forget the information before it can be entered. The probability of the user forgetting some item of information can become significant when the call or conversation has a long duration or when the call or conversation contains a relatively large amount of information for the user to remember.

Techniques described herein enable an electronic device to automatically generate an action list based on the content of a face-to-face conversation or phone call and to provide a user with an option, for each action on the action list, to accept or decline performance of that particular action. For example, a smart phone device may process audio of a phone call to identify one or more actions to propose to the user, and after the call has ended, the identified actions may be presented to the user as a list of proposed actions with user-selectable “Yes” and “No” options for each action. In some examples, one or more of the proposed actions are presented with a “Modify” option that enables a user to edit a proposed action.

In a particular example, a selectable icon is presented on a screen of the electronic device. User selection of the icon, such as before or during a phone call, initiates a machine learning process that is used to recognize a speech context and to create the action list. The action list is displayed after the phone call has ended, with user-selectable “Yes” and “No” options for each proposed action. In some examples, one or more of the proposed actions are presented with a user-selectable “Modify” option. Proposed actions that can be generated and displayed based on information exchanged during a phone call include “Shall I save contact information?”, “Shall I set an alarm for 4:00 PM?”, “Set alarm to bring wallet tomorrow?”, and “Save her birthday in the calendar?” as illustrative, non-limiting examples. One or more of the proposed actions can be editable based on user input. As an example, a user can change the alarm from 4:00 PM to 3:50 PM based on various factors, such as to account for time to get ready or expected traffic, etc. The electronic device adjusts a configuration—such as by adding a contact or setting an alarm—in response to receiving user input accepting one or more of the proposed actions.

In some implementations, content parsing is performed while a phone call or face-to-face conversation is ongoing. The content parsing identifies spoken keywords and maps one or more actions to the identified keywords. To illustrate, keywords that may be detected and linked to proposed actions include “my number is,” “don't forget,” “birthday is,” and “take note of,” as illustrative, non-limiting examples. Content parsing and mapping to actions may be performed without storing an audio or textual recording of the call or conversation.

By automatically proposing a list of actions to be performed based on audio content, such as detected during a face-to-face conversation or phone call, a user can remain focused on the conversation or call without the distraction of taking notes or updating applications to store information presented during the conversation or call, and without the information being lost due to the user failing to remember the information after the conversation or call has ended. As a result, a user experience is enhanced. Further, such auto-generated lists of proposed actions based on audio content can be utilized in various other implementations and use cases, as described further in the examples below, and are not limited to face-to-face conversations and phone calls.

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” content (or a signal) may refer to actively generating, estimating, calculating, or determining the content (or the signal) or may refer to using, selecting, or accessing the content (or signal) that is already generated, such as by another component or device.

As used herein, “coupled” may include “communicatively coupled,” “electrically coupled,” or “physically coupled,” and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signal) directly or indirectly, such as via one or more wires, buses, networks, etc.

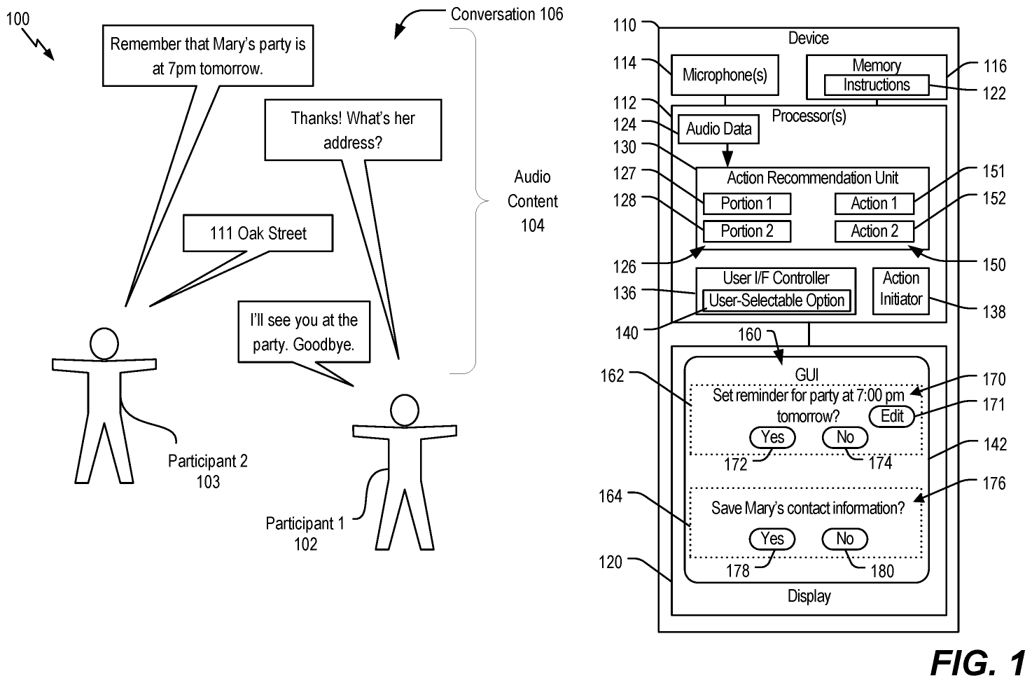

Referring to FIG. 1, an illustrative example of a system 100 is shown. The system 100 includes a device 110 that is configured to automatically propose actions based on audio content. For example, the device 110 detects audio content 104 corresponding to a conversation 106 between a first participant 102 and a second participant 103, and the device 110 determines one or more actions 150 based at least in part on the audio content 104. According to the example in FIG. 1, the audio content 104 corresponds to the phrase “Remember that Mary's party is at 7 pm tomorrow,” spoken by the second participant 103, followed by the phrase “Thanks! What's her address?” spoken by the first participant 102, followed by the phrase “111 Oak Street,” spoken by the second participant 103, followed by the phrase “I'll see you at the party. Goodbye,” spoken by the first participant 102 during the conversation 106. It should be understood that the phrases indicated in FIG. 1 are for illustrative purposes and should not be construed as limiting. In other implementations, the conversation 106 can include different phrases.

The device 110 includes one or more processors, illustrated as a processor 112. The device 110 also includes one or more microphones, illustrated as a microphone 114, coupled to the processor 112. The device 110 includes a memory 116 coupled to the processor 112 and a display 120 coupled to the processor 112. The memory 116 is a non-transitory computer-readable device that includes instructions 122 that are executable by the processor 112 to perform the operations described herein. The processor 112 includes an action recommendation unit 130, a user interface (I/F) controller 136, and an action initiator 138. In a particular aspect, the instructions 122 correspond to the action recommendation unit 130, the user interface controller 136, the action initiator 138, or a combination thereof. According to one implementation, each component 130, 136, 138 of the processor 112 can be implemented using dedicated circuitry, such as an application-specific integrated circuit (ASIC) or a field-programmable gate array (FPGA).

The microphone 114 is configured to capture the audio content 104 of the conversation 106 and generate audio data 124 that corresponds to the audio content 104. According to one implementation, the audio data 124 is an analog signal. According to another implementation, the audio data 124 is a digital signal. For example, in response to capturing the audio content 104, the microphone 114 can perform an analog-to-digital conversion (ADC) operation to convert the audio content 104 to a digital signal. The microphone 114 provides the audio data 124 to the processor 112.

The processor 112 is configured to receive the audio data 124 that corresponds to the audio content 104. The processor 112 is configured to execute the action recommendation unit 130 to process the audio data 124 to identify one or more portions 126 of the audio data 124 that are associated with one or more actions 150. For example, the action recommendation unit 130 is configured to perform an automatic speech recognition operation on the audio data 124 to determine that the portions 126 correspond to one or more spoken keywords. The action recommendation unit 130 is configured to map the spoken keywords to the actions 150. The user interface controller 136 is configured to present one or more user-selectable options, such as a user-selectable option 140, to perform the one or more actions 150. The action initiator 138 is configured to, in response to receiving a user selection indicating that an action 151 of the actions 150 is to be performed, initiate performance of the action 151.

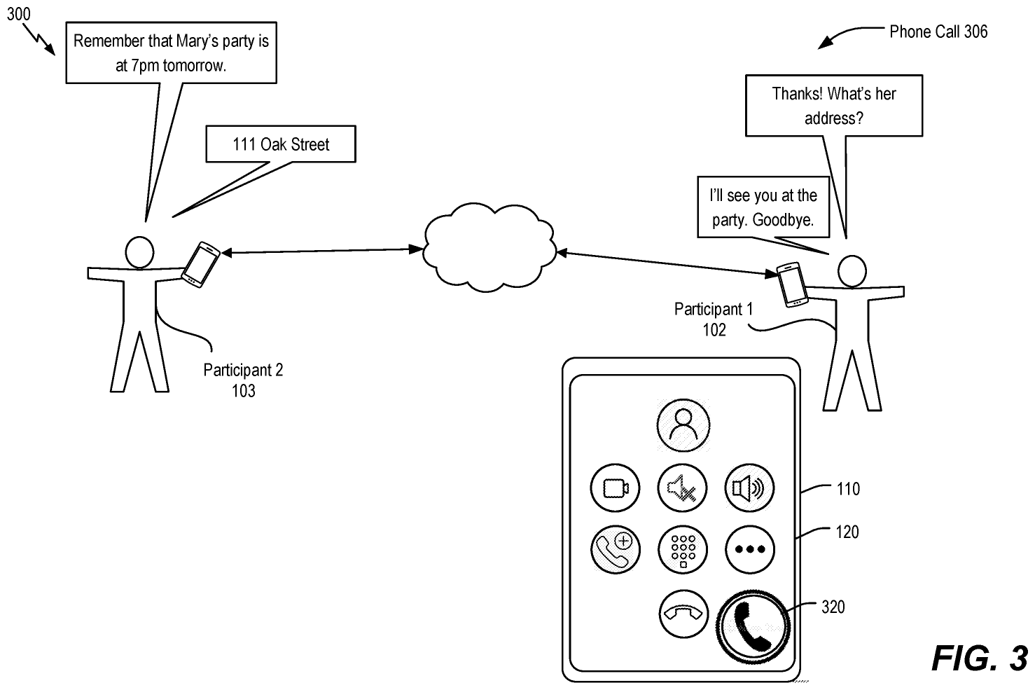

During operation, a first participant 102 engages in a conversation 106 with a second participant 103. For example, the conversation 106 occurs in person, using the device 110, or using another device between the first participant 102 and the second participant 103. In a particular example, the first participant 102 speaks directly (e.g., in person) to the second participant 103 while the device 110 (e.g., a mobile phone) of the first participant 102 is within proximity to capture the audio content 104 of the conversation 106. As another example, the conversation 106 occurs during a call (e.g., a phone call or a communication application session) between the first participant 102 and the second participant 103, such as described in further detail with respect to FIG. 3. In a particular aspect, the call occurs using the device 110. In another aspect, the call occurs using another device in speaker mode and the device 110 is within proximity of the other device to capture the audio content 104 of the conversation 106.

The microphone 114 captures the audio content 104 of the conversation 106 and generates the audio data 124 (e.g., an analog signal, a digital signal, audio frames, etc.) corresponding the audio content 104. The microphone 114 provides the audio data 124 to the action recommendation unit 130. In a particular implementation, the action recommendation unit 130 always receives the audio data 124 from the microphone 114. In another particular implementation, the action recommendation unit 130 selectively receives the audio data 124 from the microphone 114. For example, the action recommendation unit 130 selectively receives the audio data 124 from the microphone 114 based on a power-save mode of the device 110 (e.g., when the power-save mode is not enabled), a default value, a configuration setting, a user profile setting associated with the first participant 102, a user profile setting associated with the second participant 103, a call setting, an application setting, a sensor input (e.g., geographical location sensor input), or a combination thereof. To illustrate, the first participant 102 may selectively enable the action recommendation unit 130 to be executed per application, per participant, per application session, per call, per location, during particular time periods, etc.

The action recommendation unit 130 automatically processes the audio data 124 in response to receiving the audio data 124. For example, the first participant 102 does not have to pause during the conversation 106 to enable execution of the action recommendation unit 130. Alternatively, the action recommendation unit 130, in response to receiving the audio data 124, provides an option to process the audio data 124 to the display 120 and processes the audio data 124 in response to receiving a user input (e.g., a user selection of the option or a button activation) indicating that action recommendations are to be generated.

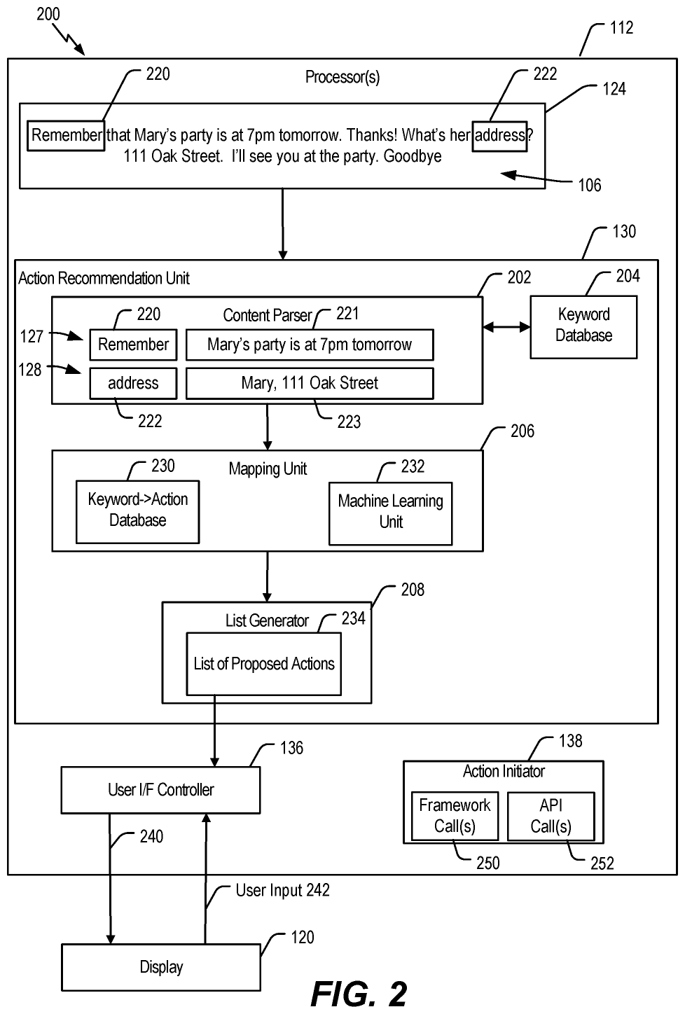

The action recommendation unit 130 processes the audio data 124 to identify one or more portions 126 of the audio data 124 that are associated with one or more actions 150, as further described with reference to FIG. 2. For example, the action recommendation unit 130 processes the audio data 124 to determine that a first portion 127 and a second portion 128 of the audio data 124 correspond to a first action 151 and a second action 152, respectively, of the actions 150. To illustrate, the action recommendation unit 130 performs speech recognition to determine that the first portion 127 corresponds to a first spoken keyword (e.g., “Remember”) and a first context (e.g., “Mary's party at 7 pm tomorrow”) and determines that the first spoken keyword corresponds to the first action 151 (e.g., “Set a reminder for party at 7 pm tomorrow”). As another example, the action recommendation unit 130 performs speech recognition to determine that the second portion 128 corresponds to a second spoken keyword (e.g., “address”) and second context (e.g., “Mary” and “111 Oak Street”) and determines that the second spoken keyword corresponds to the second action 152 (e.g., “Save Mary's contact info. to include address 111 Oak Street”).

The action recommendation unit 130 provides the actions 150 to the user interface controller 136. The user interface controller 136 presents user-selectable options to performs the actions 150. For example, the user interface controller 136 generates a graphical user interface (GUI) 142 including a list of prompts 160. Each prompt of the list of prompts 160 indicates a proposed action to be performed and one or more user-selectable controls to accept or decline performance of the proposed action. For example, the list of prompts 160 includes a first prompt 162 indicating a first proposed action 170 (e.g., “Set reminder for party at 7:00 pm tomorrow?”), a first user-selectable control 172 (e.g., “Yes”) to accept performance of the first proposed action 170, and a second user-selectable control 174 (e.g., “No”) to decline performance of the first proposed action 170. The first proposed action 170 (e.g., “Set reminder for party at 7:00 pm tomorrow?”) corresponds to the first action 151 (e.g., “Set a reminder for party at 7 pm tomorrow”). For example, the first proposed action 170 and the first action 151 corresponds to setting a reminder for an event identified in the audio data 124. A user-selectable option 140 to perform the first action 151 is presented via the first prompt 162 in the list of prompts 160. In a particular implementation, one or more prompts of the list of prompts 160 include an option to modify a proposed action. In a particular example, the first prompt 162 is editable to modify the first proposed action 170 (e.g., to modify the time for the reminder). In another example, the first prompt 162 includes a modify option 171 (e.g., a user-selectable control) to modify the first proposed action 170 (e.g., to modify the time for the reminder). To illustrate, the user interface controller 136 is configured to, in response to receiving a selection of the modify option 171, generate a second GUI that is editable to modify the first proposed action 170.

In a particular example, the list of prompts 160 includes a second prompt 164 indicating a second proposed action 176 (e.g., “Save Mary's contact information?”), a third user-selectable control 178 (e.g., “Yes”) to accept performance of the second proposed action 176, and a fourth user-selectable control 180 (e.g., “No”) to decline performance of the second proposed action 176. The second proposed action 176 (e.g., “Save Mary's contact information”) corresponds to the second action 152 (e.g., “Save Mary's contact info. to include address 111 Oak Street”). For example, the second proposed action 176 and the second action 152 include saving contact information identified in the audio data 124. In a particular implementation, the second prompt 164 is editable to modify the second proposed action 176 (e.g., to modify the name for the contact information, such as to Marie).

The user interface controller 136 provides the GUI 142 to the display 120, and the display 120 is configured to represent the GUI 142. In a particular aspect, the user interface controller 136 provides the GUI 142 to the display 120 in response to detecting an event. For example, the event includes an end of the call, an end of the conversation 106, expiration of a time period, receipt of a user input, or a combination thereof. In a particular aspect, the user interface controller 136 detects the end of the conversation 106 in response to detecting an absence of receipt of audio data associated with the first participant 102 and an absence of receipt of audio data associated with the second participant 103 during a threshold time period. In a particular aspect, the user interface controller 136 detects the end of the conversation 106 in response to determining that a camera input indicates that the first participant 102 is looking away from the second participant 103, that the first participant 102 has moved (or turned) away from the second participant 103, that the second participant 103 has moved (or turned) away from the first participant 102, that each of the first participant 102 and the second participant 103 has stopped talking, or a combination thereof. In a particular aspect, the user interface controller 136 provides the GUI 142 to the display 120 independently of detecting an event. For example, the user interface controller 136 may provide updates to the GUI 142 to the display 120 so that the GUI 142 includes additional prompts in real-time as each of the actions 150 is identified.

The first participant 102 can select one of the user-selectable controls to accept or deny performance of a proposed action. For example, the first participant 102 selects the second user-selectable control 174 to deny performance of the first proposed action 170 (e.g., “Set a reminder for party at 7 pm tomorrow”). The action initiator 138, in response to receiving the selection of the second user-selectable control 174, refrains from performing the first proposed action 170. In a particular aspect, the action recommendation unit 130, in response to receiving the selection of the second user-selectable control 174, provides a GUI to the display 120 that prompts the first participant 102 for user input regarding the action recommendations. For example, the GUI may include a prompt indicating whether to disable recommendations related to the first action 151 (e.g., “Save contact information”), whether to disable recommendations related to a particular context (e.g., “Mary”), or both. The action recommendation unit 130 can disable (e.g., remove) mappings to the first action 151 (e.g., “Save contact information”) or disable mappings to all actions for the particular context (e.g., “Mary”).

In a particular example, the action initiator 138, in response to receiving a selection of the third user-selectable control 178, initiates performance of the second proposed action 176 (e.g., the second action 152). For example, the action initiator 138 performs one or more framework calls or one or more application programming interface (API) calls to perform the second action 152 (e.g., “Save Mary's contact information to include address 111 Oak Street”). In a particular aspect, the second action 152 is performed based on user input. For example, the action initiator 138 performs the second action 152 by initiating display of a contact information screen that is pre-filled based on the context (e.g., “Mary” and “111 Oak Street”) associated with the second action 152. The first participant 102 can provide first user input to edit and/or save the contact information or provide second user input to cancel saving the contact information. In an alternative aspect, the action initiator 138 performs the second action 152 independently of user input. For example, the action initiator 138 initiates saving of the contact information in response to the receiving the selection of the third user-selectable control 178 without additional user input.

The system 100 thus enables action recommendations to be generated automatically based on the audio content 104. The first participant 102 can participate in the conversation 106 without having to pause to make notes. The auto-generated recommendations can assist in reminding the first participant 102 of details of the conversation 106. In some examples, the action recommendation unit 130 can use speech recognition to detect words spoken by the second participant 103 that are difficult to understand or remember for the first participant 102. For example, the second participant 103 could be speaking in an accent that is unfamiliar to the first participant 102, could be speaking too quickly for the first participant 102 to make notes, could be using terms that are unfamiliar to the first participant 102, or a combination thereof.

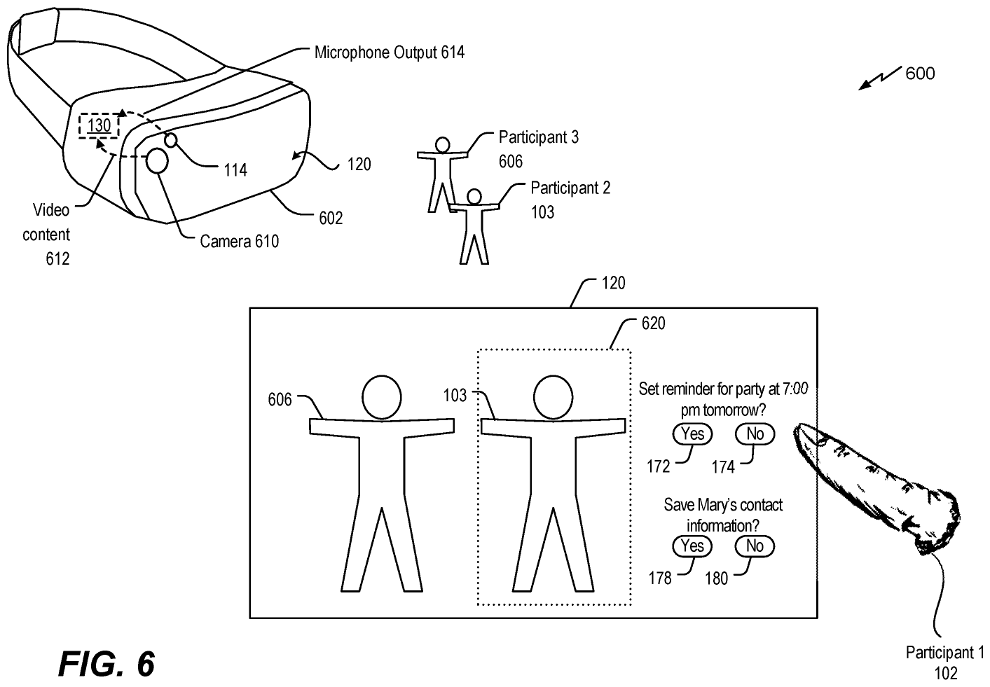

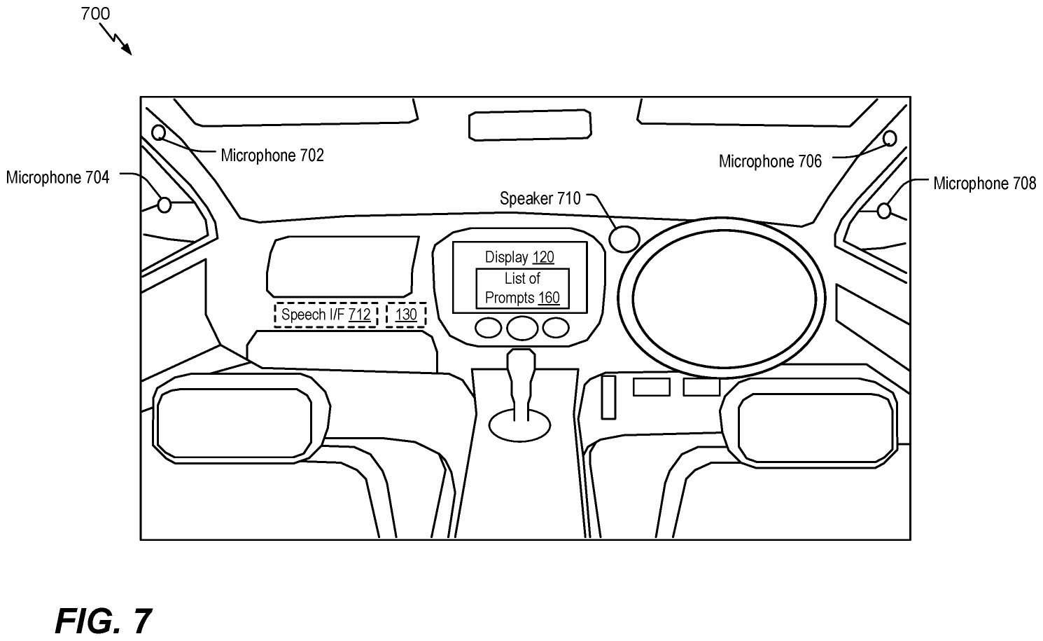

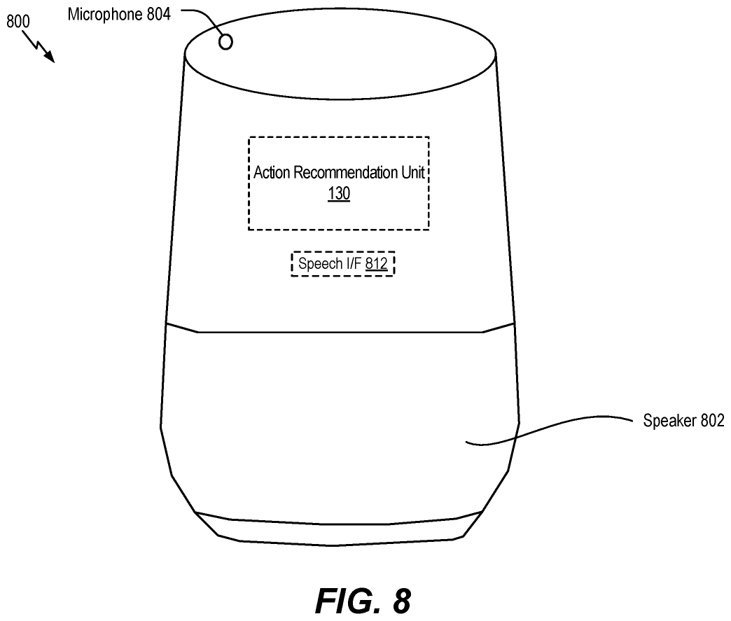

Although FIG. 1 describes implementations in which the GUI 142 is used to present user-selectable options related to the audio content 104, in other implementations non-graphical interface elements can be used. For example, in a vehicle implementation, user-selectable options can be presented audibly to an operator of the vehicle to prevent the operator from having to view a visual display, such as described further with reference to FIG. 7. Similarly, user input mechanisms such as speech recognition or gesture recognition can be used as illustrative, non-limiting alternatives to a touchscreen, keyboard, or keypad input device, such as described further with reference to FIG. 6. In some implementations, the device 110 may be implemented without a display, such as described further with reference to FIG. 8.

Although some examples of the present disclosure describe implementations in which some user-selectable options are dual-choice (e.g., yes/no) and other user-selectable options include more than two choices (e.g., yes/no/edit), in other implementations all user-selectable options are dual-choice (e.g., no modify or edit options are presented in the list), and in still other implementations all proposed actions are presented with an option to modify or edit. In some implementations a determination is made, for one or more proposed actions, whether to present user-selectable options for that particular action as dual-choice (e.g., yes/no) or with an option to modify (e.g., yes/no/edit), such as by presenting a modify option when a speech recognition score associated with an action is below a threshold amount but not presenting a modify option when the speech recognition score equals or exceeds the threshold amount. As another example, a modify option may be presented for suggested alarms or reminders based on a user's history of postponing alarms (e.g., using a snooze feature) or being delayed (e.g., due to unpredictable traffic patterns), as illustrative, non-limiting examples.

Referring to FIG. 2, a non-limiting example of a system 200 that includes components that can be implemented in the device 110 of FIG. 1 is shown. The system 200 includes the action recommendation unit 130, the user interface controller 136, and the action initiator 138. In some implementations, operations of the system 200 can be performed by the processor 112 of FIG. 1. In other implementations, one or more of the components 130, 136, 138 are implemented via circuitry or dedicated hardware.

The action recommendation unit 130 includes a content parser 202 coupled, via a mapping unit 206, to a list generator 208. The content parser 202 is coupled to a keyword database 204. In FIG. 2, the keyword database 204 is illustrated as included in the action recommendation unit 130. In other implementations, the keyword database 204 is external to the action recommendation unit 130, the device 110 of FIG. 1, or both. The mapping unit 206 includes a database 230, a machine learning unit 232, or both.

The content parser 202 is configured to identify one or more portions 126 of the audio data 124 that correspond to one or more keywords indicated by the keyword database 204. The content parser 202 is also configured to identify context information associated with the keywords indicated by the portions 126. The mapping unit 206 is configured to map the keywords to one or more actions 150. For example, the database 230 associates actions with keywords. To illustrate, the database 230 includes mappings between keywords and actions. As another example, the machine learning unit 232 is configured to identify actions corresponding to keywords received as input. The list generator 208 is configured to generate a list of proposed actions 234.

During operation, the content parser 202 receives the audio data 124 corresponding to the conversation 106. The content parser 202 performs speech recognition on the audio data 124 to identify one or more spoken words (e.g., “Remember that Mary's party is at 7 pm tomorrow. Thanks! What's her address? 111 Oak Street. I'll see you at the party. Goodbye.”) of the conversation 106. The content parser 202 compares each of the spoken words to keywords indicated by the keyword database 204 and, based on the comparison, identifies one or more portions 126 of the audio data 124 that correspond to keywords. For example, the content parser 202, in response to determining by performing speech recognition that the first portion 127 of the audio data 124 corresponds to a spoken word (e.g., “Remember”) and determining that the keyword database 204 indicates that the spoken word (e.g., “Remember”) corresponds to a keyword, designates the first portion 127 as corresponding to a first keyword 220 (e.g., “Remember”). As another example, the content parser 202 determines that the second portion 128 corresponds to a second keyword 222 (e.g., “address”).

The content parser 202, in response to determining that the first portion 127 corresponds to the first keyword 220 (e.g., “Remember”), uses speech context detection techniques to determine a first context 221 (e.g., “Mary's party is at 7 pm tomorrow”) associated with the first portion 127. For example, the content parser 202, in response to determining that the first portion 127 corresponds to the first keyword 220 (e.g., “Remember”), performs natural language processing based on the first keyword 220 (e.g., “Remember”) to determine that the corresponding spoken word (e.g., “Remember”) is associated with a subset (e.g., “Mary's party is at 7 pm tomorrow”) of the audio data 124 and generates the first context 221 (e.g., “Mary's party is at 7 pm tomorrow”) based on the identified subset of the audio data 124. In a particular example, the content parser 202, in response to determining that the second portion 128 corresponds to the second keyword 222 (e.g., “address”), uses speech context detection techniques to determine a second context 223 (e.g., “Mary, 111 Oak Street”) associated with the second portion 128.

The mapping unit 206, in response to determining that the content parser 202 has detected at least one of the keywords, identifies one or more corresponding actions 150. In a particular implementation, the mapping unit 206 identifies each of the actions 150 in real-time as each keyword is detected by the content parser 202. In another implementation, the mapping unit 206 identifies the action 150 in response to determining that the content parser 202 has completed processing of the audio data 124 and has detected at least one keyword.

The mapping unit 206 determines that the first keyword 220 (e.g., “Remember”), the first context 221 (e.g., “Mary's party is at 7 pm tomorrow”), or both, map to a first action 151 (e.g., “Set a reminder” or “Set a reminder for Mary's party at 7 pm tomorrow”). In a particular implementation, the mapping unit 206 determines that the first keyword 220 (e.g., “Remember”) maps to the first action 151 (e.g., “Set a reminder”). For example, the mapping unit 206 determines that the database 230 indicates that the first keyword 220 (e.g., “Remember”) maps to the first action 151 (e.g., “Set a reminder”). As another example, the mapping unit 206 provides the first keyword 220 (e.g., “Remember”) as input to the machine learning unit 232 and the machine learning unit 232 generates the first action 151 (e.g., “Set a reminder”) as output. In another implementation, the mapping unit 206 determines that the first keyword 220 (e.g., “Remember”) and the first context 221 (e.g., “Mary's party is at 7 pm tomorrow”) map to the first action 151 (e.g., “Set a reminder for Mary's party at 7 pm tomorrow”). For example, the mapping unit 206, in response to determining that the database 230 indicates that the first keyword 220 maps to an action (e.g., “Set a reminder”), generates the first action 151 (e.g., “Set a reminder for Mary's party at 7 pm tomorrow”) by combining the action (e.g., “Set a reminder”) and the first context 221 (e.g., “Mary's party is at 7 pm tomorrow”). As another example, the mapping unit 206 provides the first keyword 220 (e.g., “Remember”) and the first context 221 (e.g., “Mary's party is at 7 pm tomorrow”) as inputs to the machine learning unit 232 and the machine learning unit 232 generates the first action 151 (e.g., “Set a reminder for Mary's party at 7 pm tomorrow”) as output. In a particular example, the mapping unit 206 determines that the second keyword 222 (e.g., “address”), the second context 223 (e.g., “Mary, 111 Oak Street”), or both, map to a second action 152 (e.g., “Save contact information” or “Save Mary's contact information to include address 111 Oak Street”).

The list generator 208, in response to determining that the mapping unit 206 has identified at least one of the actions 150, generates (or updates) a list of proposed actions 234. In a particular implementation, the list generator 208 updates the list of proposed actions 234 in real-time as each of the actions 150 is identified by the mapping unit 206. In another implementation, the list generator 208 generates the list of proposed actions 234 in response to determining that the mapping unit 206 has completed processing any keywords identified for the audio data 124 and has identified at least one of the actions 150.

In the implementation in which the mapping unit 206 identifies the actions 150 independently of context, the list generator 208 generates the list of proposed actions 234 based on the actions 150 and context. For example, the list generator 208, in response to determining that the first action 151 (e.g., “Set a reminder”) is identified for the first portion 127 (e.g., “Remember”) and that the first portion 127 has the first context 221 (e.g., “Mary's party is at 7 pm tomorrow”), generates a first proposed action 170 (e.g., “Set reminder for Mary's party at 7 pm tomorrow?”) based on the first action 151 and the first context 221. In an alternative implementation in which the mapping unit 206 identifies the actions 150 based on context, the list generator 208 generates the list of proposed actions 234 based on the actions 150. In a particular example, the list generator 208 generates one or more proposed actions corresponding to each of the actions 150. In a particular example, the list generator 208, in response to determining that the actions 150 include a first action 151 (e.g., “Set a reminder” or “Set reminder for Mary's party at 7 pm tomorrow?”), adds a first proposed action 170 (e.g., “Set reminder for Mary's party at 7 pm tomorrow”), another proposed action (e.g., “Add a calendar event for Mary's party at 7 pm tomorrow”), or both, to the list of proposed actions 234. The list generator 208, in response to determining that the actions 150 include the second action 152 (e.g., “Save contact information” or “Save Mary's contact information to include address 111 Oak Street”), adds a second proposed action 176 (e.g., “Save Mary's contact information to include address 111 Oak Street”) to the list of proposed actions 234.

The user interface controller 136 generates display data 240 (e.g., the GUI 142 of FIG. 1) based on the list of proposed actions 234. The display data 240 includes (e.g., indicates) a list of prompts 160 corresponding to the list of proposed actions 234. For example, each prompt of the list of prompts 160 indicates a proposed action of the list of proposed actions 234 and one or more user-selectable controls to accept or decline performance of the proposed action. In a particular aspect, the list of prompts 160 includes a prompt indicating whether to save contact information identified in the audio data, a prompt indicating whether to set a reminder for an event identified in the audio data, a prompt indicating whether to update a calendar for an appointment identified in the audio data, or any combination thereof.

The user interface controller 136 provides the display data 240 to the display 120. The display 120 represents (e.g., displays) the display data 240 (e.g., the GUI 142 of FIG. 1). In a particular aspect, the user interface controller 136 provides the display data 240 in real-time to the display 120 as the display data 240 is updated. In another aspect, the user interface controller 136 provides the display data 240 in response to detecting an event. For example, the event includes an end of the call, an end of the conversation 106 of FIG. 1, expiration of a time period, receipt of a user input, or a combination thereof.

The user interface controller 136 receives a user input 242 subsequent to providing the display data 240 to the display 120. In FIG. 2, the user interface controller 136 is shown as receiving the user input 242 from the display 120 (e.g., a touch screen display) as an illustrative example. In other implementations, the user interface controller 136 receives the user input 242 from another input device, such as but not limited to, a keyboard, a computer mouse, a touch keypad, an audio sensor (e.g., a microphone), an image sensor (e.g., a camera), or a combination thereof.

The action initiator 138, in response to the user input 242 indicating a modification of a proposed action, updates the proposed action to include the modification. For example, the action initiator 138 updates the first proposed action 170 (e.g., changes reminder time to 6:50 PM) in response to receiving the user input 242 indicating a modification of the first proposed action 170 (e.g., an update of the reminder time from 7:00 PM to 6:50 PM). The action initiator 138, in response to the user input 242 indicating a selection of a user-selectable control to accept performance of a proposed action, generates one or more framework calls 250 or one or more API calls 252 to perform the proposed action. For example, the action initiator 138, in response to the user input 242 indicating a selection of the first user-selectable control 172 to accept performance of the first proposed action 170, generates one or more framework calls 250 or one or more API calls 252 to perform the first proposed action 170.

The system 200 thus enables action recommendations to be generated automatically based on the audio content 104. The action recommendations can be displayed in real-time (e.g., as the audio content 104 is received and processed) or in response to detection of an event (e.g., an expiration of a time period, an end of a call, etc.).

Referring to FIG. 3, an illustrative example of a system 300 is shown. The system 300 includes the device 110 configured to present a selectable option based on audio content of a phone call 306.

The display 120 is configured to present a user-selectable control 320 to activate automatic audio-based action recommendations. In a particular implementation, the user-selectable control 320 is displayed as part of a settings screen independently of detection of audio content. For example, the user interface controller 136 of FIG. 1, in response to determining that the settings screen is to be displayed, provides display data to the display 120 to present the user-selectable control 320. In another implementation, the user-selectable control 320 is displayed in response to detecting that a display criterion is satisfied. For example, the user interface controller 136 determines that the display criterion is satisfied based on a power-save mode of the device 110 (e.g., when power-save mode is not enabled), a particular default value, a particular configuration setting, a user profile setting associated with the first participant 102, a user profile setting associated with the second participant 103, a call setting, an application setting, a sensor input (e.g., geographical location sensor input), or a combination thereof. To illustrate, the first participant 102 may selectively enable the display criterion to be satisfied per application, per participant, per application session, per call, per location, during particular time periods, etc.

In a particular example, the user interface controller 136 determines that the display criterion is satisfied in response to determining that a call (e.g., a phone call or an application-based call) has been initiated using the device 110, that audio content 104 is being received including speech of the first participant 102 (e.g., a user of the device 110) and speech of the second participant 103 (e.g., any participant or a participant indicated by a setting), or both. The user interface controller 136, in response to determining that the display criterion is satisfied, provides display data to the display 120 to present the user-selectable control 320. The processor 112, in response to receiving a user selection of the user-selectable control 320 to activate audio-based action recommendations, initiates execution of the action recommendation unit 130. For example, the action recommendation unit 130 initiates receiving of the audio content 104 in response to the selection of the user-selectable control 320.

The system 300 thus enables the first participant 102 to selectively activate the audio-based recommendations for the phone call 306. In a particular example, the user interface controller 136 provides the GUI 142 of FIG. 1, the display data 240 of FIG. 2, or both, to the display 120 in response to detecting an end of the phone call 306.

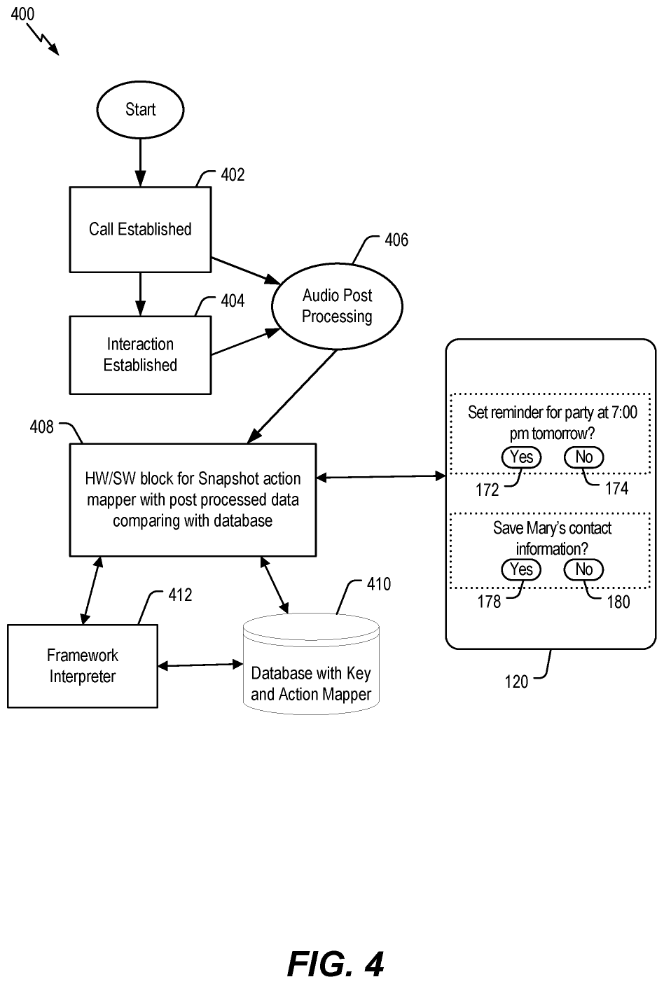

FIG. 4 is an illustrative example 400 of functions that may be performed by the device 110 of FIG. 1. In a particular aspect, one or more functions of the example 400 are performed by the processor 112, the action recommendation unit 130, the user interface controller 136, the action initiator 138, the device 110, the system 100 of FIG. 1, the content parser 202, the mapping unit 206, the list generator 208 of FIG. 2, or a combination thereof.

The device 110 establishes a call, at 402. For example, the device 110 initiates (or answers) the phone call 306 of FIG. 3 or another call of another communication application. An interaction is established, at 404. For example, the audio content 104 corresponding to the call (e.g., the phone call 306 or another call) is received by the action recommendation unit 130. Audio post processing is performed, at 406. For example, the content parser 202 of FIG. 2 processes the audio content 104, as described with reference to FIG. 2. In a particular aspect, the processor 112 activates the action recommendation unit 130 for audio processing in response to detecting that the call is established. In an alternative aspect, the processor 112 activates the action recommendation unit 130 for audio processing in response to determining that the audio content 104 for the call is being received.

A mapper (e.g., a hardware mapper or a software mapper) compares the processed data generated by the content parser 202 with a database, at 408. For example, the content parser 202 compares the one or more spoken words detected in the audio data 124 to detect any corresponding keywords indicated by the keyword database 204, as described with reference to FIGS. 1-2.

A mapper determines one or more actions 150 corresponding to the detected keywords, at 410. For example, the mapping unit 206 of FIG. 2 determines one or more actions 150 corresponding to the detected keywords associated with the portions 126, as described with reference to FIG. 2. The user interface controller 136 provides the GUI 142 of FIG. 1, the display data 240 of FIG. 2, or both, to the display 120, as described with reference to FIGS. 1-2. In a particular aspect, the action recommendation unit 130 processes the audio content 104 to present recommendation on the display 120 in real-time as the call is ongoing and the audio content 104 is received. A framework interpreter initiates performance of a proposed action, at 412. For example, the action initiator 138 performs one or more framework calls 250 or one or more API calls 252 in response to receiving the user input 242, as described with reference to FIG. 2.

The example 400 thus enables action recommendations to be generated automatically based on the audio content 104. The action recommendations can be displayed in real-time (e.g., as the audio content 104 is received and processed) or in response to detection of an event (e.g., an expiration of a time period, an end of a call, etc.).

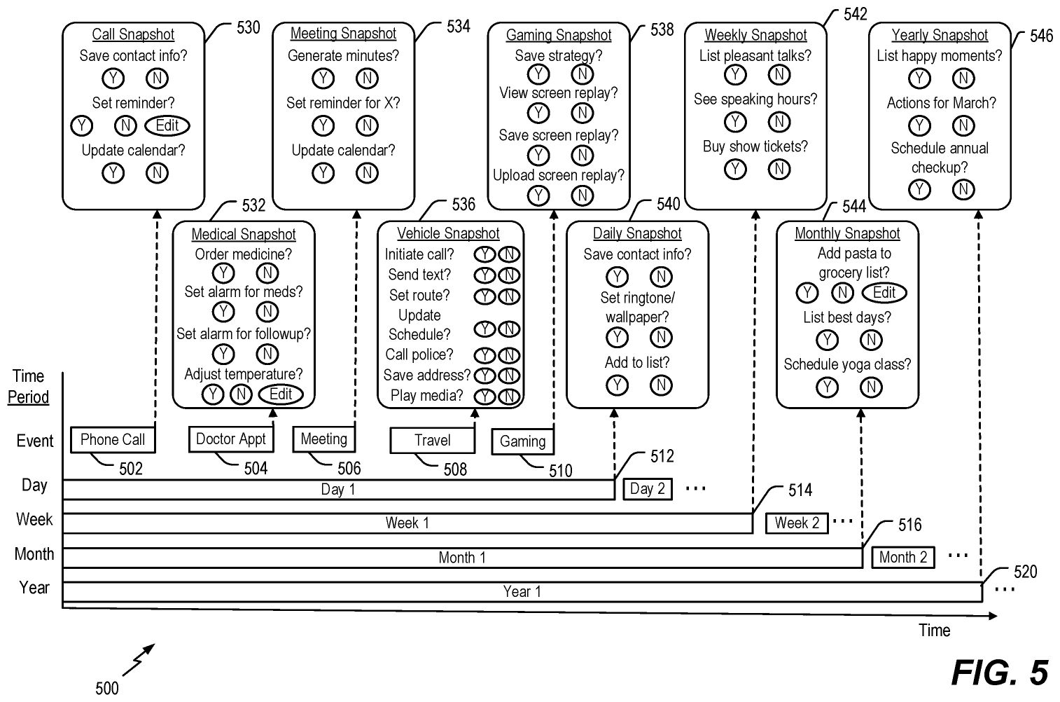

FIG. 5 is an illustrative example 500 of various lists of selectable options that may be presented by the device 110 of FIG. 1 based on detection of various events. In a particular aspect, the user interface controller 136 of FIG. 1 presents a list of selectable options by providing the GUI 142 of FIG. 1, the display data 240 of FIG. 2, or both, to the display 120.

In a particular aspect, the user interface controller 136 presents snapshots that include lists of selectable options. For example, each snapshot includes a list of prompts generated based on audio content. Each of the prompts indicates a particular proposed action based on the audio content, a first user-selectable control to accept performance of the proposed action, a second user-selectable control to deny performance of the proposed action, a modify option to edit the proposed action, or any combination thereof.

In a particular example, the user interface controller 136 generates a call snapshot 530 based on first audio content (e.g., audio content 104 of FIG. 1) of a phone call received during a first time period 502. The call snapshot 530 (e.g., the GUI 142, the display data 240, or both) includes a first list of prompts based on the first audio content. For example, the first list of prompts includes a prompt to indicate whether to save contact information identified in the first audio content, a prompt to indicate whether to save a reminder for an event identified in the first audio content, a prompt to indicate whether to update a calendar for the event identified in the first audio content, or a combination thereof. In a particular aspect, the call snapshot 530 includes a modify option (e.g., an edit option) to modify the reminder to be set.

In a particular example, the user interface controller 136 generates a medical snapshot 532 based on second audio content (e.g., audio content 104 of FIG. 1) of a conversation with a medical professional during a second time period 504. The medical snapshot 532 (e.g., the GUI 142, the display data 240, or both) includes a second list of prompts based on the second audio content. For example, the second list of prompts includes a prompt to indicate whether to place an order for prescribed medication, whether to set alarms for a medication schedule, whether to set an alarm for a follow-up visit, whether to adjust a temperature at an environmental control unit, or any combination thereof. In a particular aspect, the medical snapshot 532 includes a modify option (e.g., an edit option) to modify the temperature to be set.

In a particular example, the user interface controller 136 generates a meeting snapshot 534 based on third audio content (e.g., audio content 104 of FIG. 1) of a conversation in a meeting during a third time period 506. The meeting snapshot 534 (e.g., the GUI 142, the display data 240, or both) includes a third list of prompts based on the third audio content. For example, the third list of prompts includes a prompt to indicate whether to generate minutes of a meeting, a prompt to indicate whether to set a reminder for an event identified in the third audio content, a prompt to indicate whether to update a calendar for the event identified in the third audio content, or any combination thereof.

In a particular example, the user interface controller 136 generates a vehicle snapshot 536 based on fourth audio content (e.g., audio content 104 of FIG. 1) captured by one or more microphones of a vehicle during a fourth time period 508. The vehicle snapshot 536 (e.g., the GUI 142, the display data 240, or both) includes a fourth list of prompts based on the fourth audio content. For example, the fourth list of prompts includes a prompt to indicate whether to initiate a phone call, a prompt to indicate whether to send a text message, a prompt to indicate whether to set a travel route, a prompt to indicate whether to update a meeting schedule, a prompt to indicate whether to notify emergency personnel, a prompt to indicate whether to save one or more addresses, a prompt to indicate whether to play a media selection, or any combination thereof.

In a particular example, the user interface controller 136 generates a gaming snapshot 538 based on fifth audio content (e.g., audio content 104 of FIG. 1) of player conversations of a multi-player game during a fifth time period 510. The gaming snapshot 538 (e.g., the GUI 142, the display data 240, or both) includes a fifth list of prompts based on the fifth audio content. For example, the fifth list of prompts includes a prompt to indicate whether to save a strategy of one of the players, whether to view a screen replay of at least a portion of the multi-player game, whether to save the screen replay, whether to upload the screen replay to a social media account, or any combination thereof.

Although in some implementations user interface controller 136 provides one or more snapshots to the display 120 upon detecting a conclusion of the respective events (e.g., upon disconnection of a phone call), in some implementations the user interface controller 136 provides one or more snapshots to the display 120 in real-time. For example, the user interface controller 136 provides the call snapshot 530, the medical snapshot 532, the meeting snapshot 534, the vehicle snapshot 536, the gaming snapshot 538, or a combination thereof, to the display 120 during the first time period 502, the second time period 504, the third time period 506, the fourth time period 508, or the fifth time period 510, respectively.

As illustrated in FIG. 5, the user interface controller 136 provides one or more snapshots to the display 120 in response to detecting that a corresponding conversation has ended. For example, the user interface controller 136 provides the call snapshot 530 to the display 120 subsequent to the first time period 502 in response to detecting that the call has ended. In a particular example, the user interface controller 136 provides the medical snapshot 532 to the display 120 subsequent to the second time period 504 in response to detecting that the conversation with the medical professional has ended. In another example, the user interface controller 136 provides the meeting snapshot 534 to the display 120 subsequent to the third time period 506 in response to detecting that the meeting has ended. In a particular example, the user interface controller 136 provides the vehicle snapshot 536 to the display 120 subsequent to the fourth time period 508 in response to detecting that the first participant 102, the device 110, or both, have exited the vehicle. In another example, the user interface controller 136 provides the gaming snapshot 538 to the display 120 subsequent to the fifth time period 510 in response to detecting that the multi-player gaming session has ended.

In a particular aspect, the user interface controller 136 provides a time-based snapshot to the display 120. For example, the user interface controller 136 provides a daily snapshot 540, a weekly snapshot 542, a monthly snapshot 544, a yearly snapshot 546, another time-based snapshot, or a combination thereof, to the display 120. In a particular implementation, the user interface controller 136 automatically provides a time-based snapshot to the display 120 in response to detecting that a corresponding time period has expired. For example, the user interface controller 136 provides the daily snapshot 540, the weekly snapshot 542, the monthly snapshot 544, or the yearly snapshot 546 in response to detecting expiration of a sixth time period 512 (e.g., Day 1), a seventh time period 514 (e.g., Week 1), an eighth time period 516 (e.g., Month 1), or a ninth time period 520 (e.g., Year 1), respectively.

In a particular implementation, the user interface controller 136, in response to receiving a user input indicating a time period, provides a time-based snapshot for the time period. For example, the daily snapshot 540, the weekly snapshot 542, the monthly snapshot 544, the yearly snapshot 546, and another time-based snapshot are based on audio content received during a day, a week, a month, a year, and another time period, respectively.

Each of the time-based snapshots includes a list of prompts generated based on particular audio content received during a corresponding time period. For example, the action recommendation unit 130, in response to detecting a particular type of sounds (e.g., music, nature sounds, etc.) during the time period, generates a proposed action to add the sounds as a ringtone for the device 110, a proposed action to use the sounds as an alarm, a proposed action to playback the sounds, or a combination thereof. In a particular example, the action recommendation unit 130, determines that sounds correspond to the particular type in response to determining that particular expressions (e.g., “beautiful sounds”, “an amazing singer”, etc.) are uttered during or within a threshold duration of capturing the sounds. In another example, the action recommendation unit 130, in response to detecting that particular expressions (e.g., “Wow”, “what a lovely view”, etc.) are uttered within a threshold duration of capturing an image, generates a proposed action to use the image as a wallpaper for the device 110.

In a particular aspect, the content parser 202 stores the identified keywords and corresponding context in a memory with a timestamp. In a particular aspect, the mapping unit 206 stores the actions 150 in the memory with a timestamp. In a particular aspect, the list generator 208 stores the list of proposed actions 234 in the memory with a timestamp. In a particular aspect, the action recommendation unit 130 generates a time-based snapshot based on the identified keywords, the corresponding context, the actions 150, the list of proposed actions 234, or a combination thereof, that have a timestamp that is within a time period corresponding to the time-based snapshot. For example, the action recommendation unit 130 generates the daily snapshot 540 for a particular day to include proposed actions from lists of proposed actions with timestamps within the particular day. In a particular aspect, the action recommendation unit 130 refrains from copying a proposed action to a time-based snapshot from the lists of proposed actions in response to determining that the proposed action is associated with an event that is in the past. For example, a daily snapshot 540 generated at 9:00 PM on Mar. 2, 2021 may exclude a proposed action to set a reminder or a calendar appointment for an event that is scheduled to occur prior to 9:00 PM on Mar. 2, 2021.

In a particular aspect, the action recommendation unit 130 can add one or more proposed actions to a time-based snapshot that corresponds to a first time period based on audio content received during a second time period that is distinct from the first time period. For example, the action recommendation unit 130, in response to determining that a first event (e.g., “watching a movie in the cinema”) with a first context (e.g., “with Mary, on Friday”) was detected based on first audio content received during a first time period (e.g., last Wednesday) and that the first event is detected based on second audio content received during a second time period (e.g., today) with a second context (e.g., “on Friday”), adds a proposed action (e.g., “send an invite to Mary for the movie?”) based on the first context (e.g., “with Mary, on Friday”) to a daily snapshot 540 for the second time period (e.g., today). As another example, the action recommendation unit 130, in response to determining that a first event (e.g., “attending a celebration”) with a first context (e.g., “Omar's birthday”) was detected based on first audio content received during a first time period (e.g., March 2019), adds a proposed action (e.g., “send birthday wishes to Omar?”) to a monthly snapshot 544 for a second time period (e.g., March 2020).

In a particular aspect, the action recommendation unit 130 can generate a time-based snapshot based on an emotion (e.g., laughing, happy, angry, etc.) detected in audio content received during a corresponding time period. For example, the action recommendation unit 130 can generate the yearly snapshot 546 including proposed actions associated with happy (e.g., laughing or upbeat speech) moments, proposed actions associated with angry (e.g., terse or loud) moments, or a combination thereof. To illustrate, the proposed actions can include setting a reminder to schedule an activity previously detected in a happy moment, scheduling a massage during a particular time period (e.g., next March) in response to detecting angry moments during a previous time period (e.g., previous March), or both. In a particular implementation, the user interface controller 136 can display the proposed actions by time ranges. For example, the user interface controller 136 can generate the yearly snapshot 546 to display the proposed actions by day, week, or month of the corresponding year.

In a particular aspect, the user interface controller 136 can display the yearly snapshot 546 including options to display proposed actions associated with particular type of moments (e.g., interesting moments) detected during particular time ranges (e.g., by day, week, or month) of the corresponding year. The particular type of moment can include a conversation during travel, a conversation with a particular person (e.g., a child), a conversation with greater than threshold energy or volume, a conversation about a particular subject, or a combination thereof. For example, the yearly snapshot 546 can include proposed actions to be performed during particular time ranges (e.g., daily, weekly, or monthly) based on a conversation detected with a doctor during the corresponding year. To illustrate, the proposed actions can include setting a daily reminder to exercise, adding doctor recommended food items to a weekly grocery list, scheduling a follow-up appointment, or a reminder to refill a prescription, as illustrative non-limiting examples. In another example, the monthly snapshot 544 can include proposed actions to be performed based on a conversation detected with the family during a month. To illustrate, the proposed actions can include generating (or updating) a shopping list (e.g., a grocery list) based on items discussed during a conversation with the family. In a particular aspect, the monthly snapshot 544 includes a modify option (e.g., an edit option) to modify the item to be added to the shopping list.

In a particular aspect, the action recommendation unit 130 can generate statistics based on detected conversations and can generate proposed actions based on the statistics. The user interface controller 136 can generate the GUI 142 to indicate the statistics, the proposed actions, or a combination thereof. For example, the monthly snapshot 544 can include statistics indicating best, moderate, or worst days in a month. In a particular aspect, a best day corresponds to audio content indicating laughter more than a threshold count during the day, a worst day corresponds to audio content indicating anger or sadness more than a threshold count during the day, and a moderate day correspond to audio content indicating laughter fewer than a threshold count and anger or sadness fewer than a threshold count. In a particular example, the monthly snapshot 544 can include one or more proposed actions (e.g., scheduling a yoga session) based on determining that a count of a particular type of days (e.g., worst days) is greater than a threshold. In a particular example, the weekly snapshot 542 includes statistics regarding a number of hours spent speaking on average or during particular time ranges (e.g., by day) during a week. In a particular example, the user interface controller 136, in response to detecting an upcoming holiday (e.g., a weekend or new years) on a user calendar, generates the weekly snapshot 542 including proposed actions to schedule activities based on audio content received during the week. To illustrate, activities include visiting a place (e.g., a park) or event (e.g., a show) that was discussed favorably (e.g., “wow that sounds like fun”), for which plans were made (e.g., “we should go there”), for which directions were discussed (e.g., “where is that”), or a combination thereof.

In a particular example, the weekly snapshot 542 includes options to list particular types of conversations (e.g., unpleasant conversations, pleasant conversations, conversations related to real estate, etc.) and corresponding proposed actions. For example, a user can select an option to list conversations related to real estate, and the user interface controller 136 can list conversations detected during the week that were related to real estate with a summary or details of the conversation, along with one or more proposed actions for each conversation (e.g., send a follow up email).

The device 110 may thus present various selectable options based on detecting various events. For example, the selectable options can be presented automatically based on detecting expiration of a time period. As another example, the selectable options can be presented in response to receiving a user input indicating a time period.

The examples shown in FIG. 5 are illustrative. The device 110 can present selectable options in various other cases, including but not limited to:

In a particular example, the action recommendation unit 130, in response to detecting low call quality, generates a proposed action to switch to a data channel. For example, the action recommendation unit 130, in response to detecting lower than threshold call quality via a cellular network, generates a proposed action to switch to a data channel. In a particular aspect, the action recommendation unit 130 determines a call quality by determining a signal-to-noise ratio, by detecting repetition of particular phrases (e.g., “What”, “Not able to hear you”, “Could you repeat that”, etc.), or both. As another example, the action recommendation unit 130, in response to detecting lower than threshold call quality via a first data channel, generates a proposed action to switch to a second data channel.

In a particular example, the action recommendation unit 130, in response to detecting that a question was asked and not answered during a conversation, generates a recommendation to follow-up on the question. For example, the action recommendation unit 130, in response to determining that the first participant 102 asked the question, generates a proposed action to send a message to the second participant 103 regarding the question. As another example, the action recommendation unit 130, in response to determining that the second participant 103 asked the question, generates a proposed action to set a reminder for the first participant 102 to send an answer to the second participant 103.

In a particular example, the action recommendation unit 130 generates a proposed action to send meeting minutes to participants of a meeting. For example, the meeting minutes can indicate other proposed actions (e.g., follow up on a question, set an appointment in a calendar, etc.) that are generated based on audio captured during the meeting. In a particular aspect, the action recommendation unit 130 generates a proposed action to save questionnaire responses of participants received during the meeting. In a particular aspect, the action recommendation unit 130, in response to identifying an event for a particular time slot based on audio captured during the meeting, generates a proposed action to add an appointment in a calendar for the event. In a particular aspect, the action recommendation unit 130, in response to determining that another event is scheduled for a conflicting time (e.g., an overlapping time or a consecutive time slot), generates an alert (e.g., an audio alert, a visual alert, a haptic alert, or a combination thereof) indicating a conflict, generates a proposed action to reschedule the other event, a proposed action to send a notification to participants of the other event of rescheduling, a proposed action to send a notification of a possible delay in reaching the other event, a proposed action to send a notification of possible early departure from the other event, a proposed action to schedule the event for another available time slot, or a combination thereof. In a particular aspect, the action recommendation unit 130, in response to determining that an invite for another event for a conflicting time is received, generates a proposed action to prioritize the detected event or the other event.

In a particular example, the action recommendation unit 130, in response to detecting that the first participant 102 has boarded an airplane, generates a proposed action to set the device 110 to airplane mode, a proposed action to play a music playlist, a proposed action to reserve transportation (e.g., a cab) upon arrival to a destination indicated by calendar data, or a combination thereof.

In a particular example, the action recommendation unit 130, in response to determining that the first participant 102 had a conversation with a new person (e.g., a voice print or a phone number of the second participant 103 is not stored), generates a proposed action to save contact information for the second participant 103. In a particular example, the action recommendation unit 130, in response to determining that speech of the first participant 102 indicated a particular emotion during at least a threshold portion of a time period (e.g., a day), generates a proposed action to mark the time period as memorable with a memory tag. For example, the proposed action marks images, sounds, events, or a combination thereof, detected during the time period with the memory tag.

In a particular example, the action recommendation unit 130, in response to detecting particular phrases (e.g., “How long has it been”, “can't remember where we met”, etc.) during a conversation between the first participant 102 and the second participant 103 and determining that the second participant 103 is a known contact (e.g., a voice print associated with a contact matches a voice print of the second participant 103), identifies a previous interaction with the second participant 103 based on historic data and generates an alert indicating a time, a location, an event, or a combination thereof, associated with the previous interaction. In a particular aspect, the alert indicates stored information (e.g., name, profession, hobbies, names of family members, names of common acquaintances, etc.) associated with the contact. In a particular aspect, the action recommendation unit 130, in response to determining that the second participant 103 is a known contact, generates a proposed action to post an update to a social media account indicating the first participant 102 and the second participant 103, a proposed action to update the contact based on information detected during the conversation (e.g., name, profession, hobbies, names of family members, names of common acquaintances, etc.), a proposed action to exchange business profiles, or a combination thereof.

In a particular example, the action recommendation unit 130, in response to determining that voice of the second participant 103 is detected during a first trip (e.g., to a first location) and is not detected during a second trip (e.g., from the first location), generates a proposed action to contact (e.g., via a call or a video conference) the second participant 103. In a particular aspect, the action recommendation unit 130, in response to detecting voices planning a trip to a destination that is at least a threshold distance away from a location of the device 110, generates a proposed action to identify a location of interest (e.g., a gas station, a restaurant, a popular sightseeing spot, etc.) along a route to the destination.

In a particular aspect, the action recommendation unit 130 receives an infrastructure message from an infrastructure server indicating traffic along a selected route to a destination. For example, the infrastructure message is based on a traffic notification from a route planning application. In a particular example, the infrastructure message is based on messages exchanged between devices traveling along the route that include particular keywords (e.g., “stuck in traffic”, “accident”, “delay”, etc.). The action recommendation unit 130, in response to receiving the infrastructure message, generates a proposed action to identify an alternate route, a proposed action to postpone a meeting, a proposed action to reschedule a meeting to a time that is based on traffic conditions, a proposed action to send a notification indicating a possible delay in reaching the meeting, a proposed action to set an upper speed limit, or a combination thereof. In a particular aspect, the action recommendation unit 130, in response to receiving the infrastructure message prior to departing for the destination, generates a proposed action to set a reminder to depart for the destination at a first time to arrive by a scheduled time based on predicted traffic conditions, generates a proposed action to reschedule a reservation to a time corresponding to lower predicted traffic.

In a particular example, the action recommendation unit 130 receives a notification indicating that a particular user (e.g., a teen driver) is detected as operating a particular vehicle. The action recommendation unit 130, in response to receiving the notification, generates a proposed action to monitor a location, a speed, or both, of the vehicle, a proposed action to enable speed alerts based on a detected speed of the vehicle, or both. In a particular aspect, the action recommendation unit 130, in response to determining that the notification indicates that the particular vehicle is detected as engaging in particular behavior (e.g., traveling faster than a threshold speed, breaking a traffic rule, weaving in traffic, etc.), generates a proposed action to send an instruction to output an alert at a device of the user, the vehicle, or both, generates a proposed action to send a command to set an upper allowable speed of the vehicle, or both.

In a particular aspect, the action recommendation unit 130, in response to detecting audio (e.g., screaming, “help”, “let me go”, “get away from me”, “call the police”, “call an ambulance”, sounds indicating a car accident, etc.) indicating an emergency, automatically performs one or more emergency actions. An emergency action can include generating a loud sound to solicit help from bystanders or to scare away a perpetrator, sending an emergency notification (e.g., including a captured image, captured audio, a detected location, or a combination thereof) to emergency professionals, sending a notification to emergency contacts (e.g., a friend, a spouse, a parent, or another relative), or a combination thereof.

In a particular aspect, the action recommendation unit 130, in response to identifying a particular item discussed in a conversation and determining that the particular item is available at a particular seller, generates a proposed action to order the particular item from the particular seller. In a particular aspect, the action recommendation unit 130, in response to identifying a particular food item discussed in a conversation, generates a proposed action to find a recipe for the particular food item, a proposed action to find a seller of the particular food item, a proposed action to order the particular food item from a seller, or a combination thereof. In a particular aspect, the action recommendation unit 130, in response to identifying a particular destination discussed in a conversation, generates a proposed action to add the particular destination to a places-to-visit list.

In a particular example, the action recommendation unit 130, in response to detecting a business related conversation with the second participant 103, generates a proposed action to add contact information related to a contact discussed during the conversation, a proposed action to add a location of the conversation for a next meeting with the second participant 103, a proposed action to mark the duration and date of the conversation for billing purposes, a proposed action to set a reminder for a date mentioned during the conversation, or a combination thereof.

In a particular example, the action recommendation unit 130, in response to detecting particular phrases (e.g., “let's steal it”) in audio captured in proximity of a vehicle, sends an alert to a user of the vehicle (e.g., the first participant 102), displays an alert when the user returns to the vehicle, generates a proposed action to mark the location as unsafe, or a combination thereof. In a particular example, the action recommendation unit 130, in response to detecting particular phrases (e.g., “that's nice”, “I'd like to buy that”, etc.) in proximity of an item (e.g., a vehicle), generates a list of similar items, generates a proposed action to contact a seller of the item, or both.

In a particular aspect, the action recommendation unit 130, in response to detecting plans to play particular media (e.g., a video, music, an audiobook, etc.) during a drive and determining that a vehicle has started, generates a proposed action to start playback of the particular media. In a particular aspect, the action recommendation unit 130, in response to detecting bill payment language (e.g., “That'll be $20”, “I'll pay for that”, etc.), generates a proposed action to launch a payment application, a proposed action to launch a camera scanner, or both. In a particular aspect, the action recommendation unit 130, in response to detecting a discussion to take a picture (e.g., “let's take a selfie”, “time for a picture”, etc.), generates a proposed action to launch a camera application to take a picture.

In a particular aspect, the action recommendation unit 130 generates a proposed action related to audio detected inside or outside of a vehicle. For example, one or more microphones inside the vehicle may detect the sound of a baby crying. In a particular aspect, the action recommendation unit 130 generates a proposed action in response to detecting the baby crying, such as to propose playing soothing music that the baby likes. As another example, one or more microphones external to the vehicle may detect an external sound, such as a song, or sounds of a carnival or festival, or soothing nature sounds, that may be inaudible to occupants inside of the vehicle (e.g., when the vehicle is in motion with windows closed), and the action recommendation unit 130 generates a proposed action such as “do you want to park the vehicle and listen to the outside sounds?” As another example, in response to the external microphones detecting a song playing and the internal microphones detecting an occupant of the vehicle discussing the song, such as “this is a good song” or “which film is this from?” the action recommendation unit 130 generates a proposed action such as “This song is from [movie name], shall I play it for you?”

In a particular aspect, the action recommendation unit 130 generates a proposed action related to an interaction detected at a child's wearable device. For example, a wearable device with a microphone may be attached to a child (e.g., as a watch or bracelet that is not removable by the child) and configured to forward audio captured by the microphone to a device of a parent or guardian, or to perform onboard audio processing and to forward results to the parent or guardian's device. In a particular aspect, the action recommendation unit 130 generates a proposed action in response to detecting suspicious words or phrases, such as asking the child if the child would like chocolates or candy, asking the child if the child would like to see magic, or asking the child if the child would like to leave (e.g., to another place that has candy or dolls). Examples of the proposed actions include asking the parent or guardian whether to get the GPS location of the child's wearable device, whether to instruct the child not to leave (e.g., via an audio message playback or voice call from the parent or guardian), or a combination thereof.

In a particular aspect, the action recommendation unit 130 generates a proposed action related to an interaction with an agricultural or governmental-type institution. For example, an interaction with an agricultural entity can include instructions regarding per-acre recommendation for water or pesticides for a particular crop type or recommended crop types per climate region. In a particular aspect, the action recommendation unit 130 generates a proposed action to set reminders regarding the suggested pesticide usage, a proposed action to monitor water usage to turn on or off motors of watering machinery according to the suggested watering guidelines, a proposed action to send a notification to a farmer to use a particular recommended pesticide at a particular time, or any combination thereof. In another example, in response to detecting audio indicating a discussion with a governmental institute, the action recommendation unit 130 generates a proposed action to set a reminder for a particular date to take specific documents to the requesting institute.

FIG. 6 is an illustrative an example 600 of a wearable device 602 configured to present a selectable option based on audio content. The wearable device 602 includes the display 120 that enables a user to accept or deny performance of actions recommended based on received audio content. In the illustrated example of FIG. 6, the wearable device 602 can be a virtual reality headset, an augmented reality headset, or a mixed reality headset. The wearable device 602 can correspond to the device 110 or the device 110 can be integrated in the wearable device 602 or coupled to the wearable device 602 (e.g., in another wearable device or in a mobile device that interacts with the wearable device 602).

The wearable device 602 includes one or more microphones, such as the microphone 114, configured to capture audio of at least a portion of a conversation or a phone call and to generate a microphone output 614. In a particular aspect, the microphone output 614 corresponds to the audio data 124 of FIG. 1. In a particular aspect, the wearable device 602 includes one or more cameras 610. The action recommendation unit 130 is configured to receive video content 612 from the cameras 610 and to determine user gaze direction information 620 based on the video content 612. For example, the action recommendation unit 130 processes the video content 612 by using gaze direction detection techniques to determine a gaze direction of the first participant 102 (e.g., a user of the wearable device 602), a second gaze direction of the second participant 103, a third gaze direction of a third participant 606, or a combination thereof.

The action recommendation unit 130 (depicted using dashed lines to indicate an internal component that may not be visible at an exterior of the wearable device 602) attributes one or more portions of the audio data 124 to one or more participants based on the gaze direction information 620. For example, the action recommendation unit 130, in response to determining that the first gaze direction indicates the first participant 102 is looking at the second participant 103 when the first portion 127 is received, determines that the first portion 127 is included in a conversation between the first participant 102 and the second participant 103.

The display 120 displays the user-selectable controls 172, 174, 178, and 180. The first participant 102 can select one of the user-selectable controls 172, 174, 178, or 180 to accept or deny performance of a corresponding proposed action. For example, as a result of receiving a user selection of the first user-selectable control 172, the action recommendation unit 130 can initiate performance of the first proposed action 170. As another example, as a result of receiving a user selection of the third user-selectable control 178, the action recommendation unit 130 can initiate performance of the second proposed action 176.

Thus, the techniques described with respect to FIG. 6 enables the first participant 102 to initiate performance of one or more proposed actions that are recommended based on audio captured by the wearable device 602.

FIG. 7 is an illustrative example of a vehicle 700. According to one implementation, the vehicle 700 is a self-driving car. According to other implementations, the vehicle 700 can be a car, a truck, a motorcycle, an aircraft, a water vehicle, etc. The vehicle 700 includes a display 120 configured to present a selectable option based on received audio content and that enables a user to accept or deny performance of actions recommended based on the received audio content. The vehicle 7000 can correspond to the device 110, or the device 110 can be integrated in the vehicle 700 or coupled to the vehicle 700.

The vehicle 700 includes one or more microphones, such as a microphone 702, a microphone 704, a microphone 706, a microphone 708, or a combination thereof. In a particular aspect, the microphone 114 of FIG. 1 corresponds to the microphone 702, the microphone 704, the microphone 706, the microphone 708, or a combination thereof. For example, one or more of the microphone 702, the microphone 704, the microphone 706, or the microphone 708 are configured to capture audio of at least a portion of a conversation or a call and to generate the audio data 124 of FIG. 1. The microphones 702 and 706 are configured to capture audio within an interior of the vehicle 700 (e.g. from the vehicle operator or passengers), and the microphones 704, 706 are configured to capture audio from the exterior of the vehicle 700 (e.g., ambient sounds or conversations of nearby pedestrians or others).

The display 120 can be configured to display the list of prompts 160, such as including the user-selectable controls 172, 174, 178, and 180. The first participant 102 can select one of the user-selectable controls 172, 174, 178, or 180 to accept or deny performance of a corresponding proposed action. For example, as a result of receiving a user selection of the first user-selectable control 172, the action recommendation unit 130 can initiate performance of the first proposed action 170. As another example, as a result of receiving a user selection of the third user-selectable control 178, the action recommendation unit 130 can initiate performance of the second proposed action 176.

In a particular aspect, the vehicle 700 includes one or more loudspeakers 710 that are configured to present user-selectable options (corresponding to the user-selectable controls 172, 174, 178, and 180) via a speech interface 712. For example, the first participant 102 (e.g., a passenger or a driver) can hear the user-selectable options and use a verbal command to select one of the user-selectable options. To illustrate, the driver of the vehicle 700 can verbally select one of the user-selectable options without having to look at the display 120 to maintain the focus on driving. Likewise, a passenger sitting out of reach of the display 120 can verbally select one of the user-selectable options.

Thus, the techniques described with respect to FIG. 7 enables the first participant 102 to initiate performance of one or more proposed actions that are recommended based on audio captured by the vehicle 700.

FIG. 8 is an illustrative example of a voice-controlled speaker system 800. The voice-controlled speaker system 800 can have wireless network connectivity and is configured to execute an assistant operation. The device 110 is included in the voice-controlled speaker system 800. For example, the voice-controlled speaker system 800 includes the action recommendation unit 130. The voice-controlled speaker system 800 also includes a speaker 802 and a microphone 804. In response to receiving a verbal command, the voice-controlled speaker system 800 can execute assistant operations. The assistant operations can include adjusting a temperature, playing music, turning on lights, etc. In some implementations, the voice-controlled speaker system 800 can present user-selectable options (corresponding to the user-selectable controls 172, 174, 178, and 180) via a speech interface 812 and the microphone 804. In a particular aspect, the microphone 804 corresponds to the microphone 114 of FIG. 1. The first participant 102 can hear the user-selectable options and use a verbal command to select one of the user-selectable options.

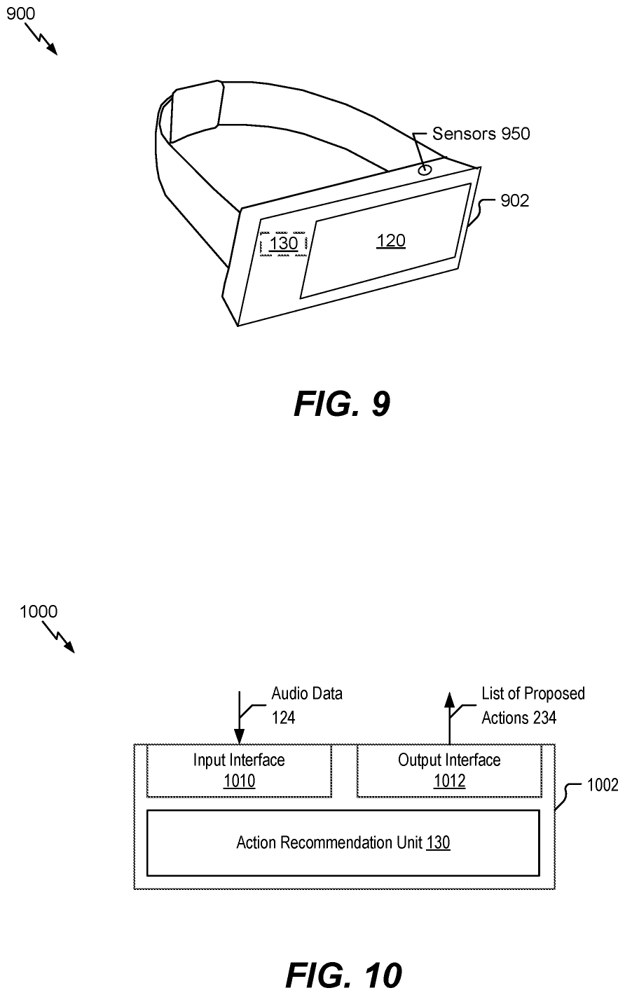

FIG. 9 depicts an example 900 of the action recommendation unit 130 integrated into a wearable electronic device 902, illustrated as a “smart watch,” that includes the display 120 and one or more sensors 950. The sensors 950 enable detection, for example, of user input based on modalities such as video, speech, and gesture. In a particular aspect, the sensors 950 include the microphone 114 of FIG. 1. Also, although illustrated in a single location, in other implementations one or more of the sensors 950 can be positioned at other locations of the wearable electronic device 902.

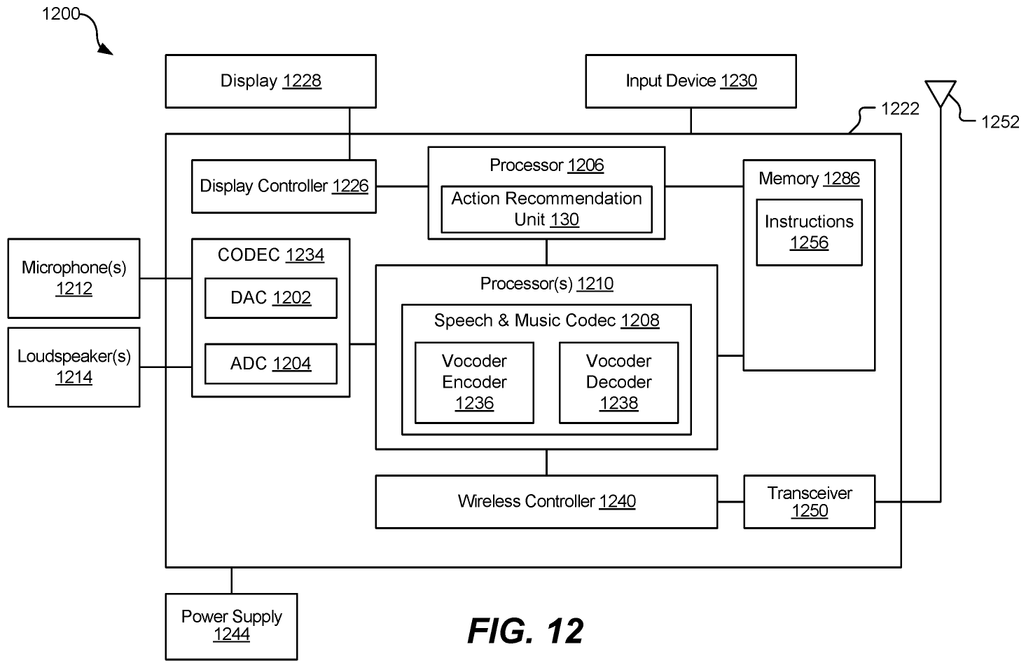

FIG. 10 is an illustrative example of a system 1000 including a device 1002 configured to present a selectable option based on audio content. In a particular aspect, the device 1002 includes the action recommendation unit 130 integrated in a discrete component, such as a semiconductor chip or package as described further with reference to FIG. 12, and corresponds to one or more components of the device 110 of FIG. 1. To illustrate, the device 1002 can include one or more processors (e.g., the processor 112) configured to execute stored instructions to perform operations described with respect to the action recommendation unit 130. The device 1002 includes an input interface 1010, such as a first bus interface, to enable audio data 124 to be received from one or more sensors external to the device 1002, such as data from the microphone 114 of FIG. 1. The device 1002 also includes an output interface 1012, such as a second bus interface, to enable sending of the list of proposed actions 234 (e.g., to the user interface controller 136). The device 1002 enables implementation of action recommendation as a component in a system that includes multiple sensors and an output device, such as in a virtual reality or augmented reality headset as depicted in FIG. 6, a vehicle as depicted in FIG. 7, a voice-controlled speaker system as depicted in FIG. 8, a wearable electronic device as depicted in FIG. 9, or a wireless communication device as depicted in FIG. 12.

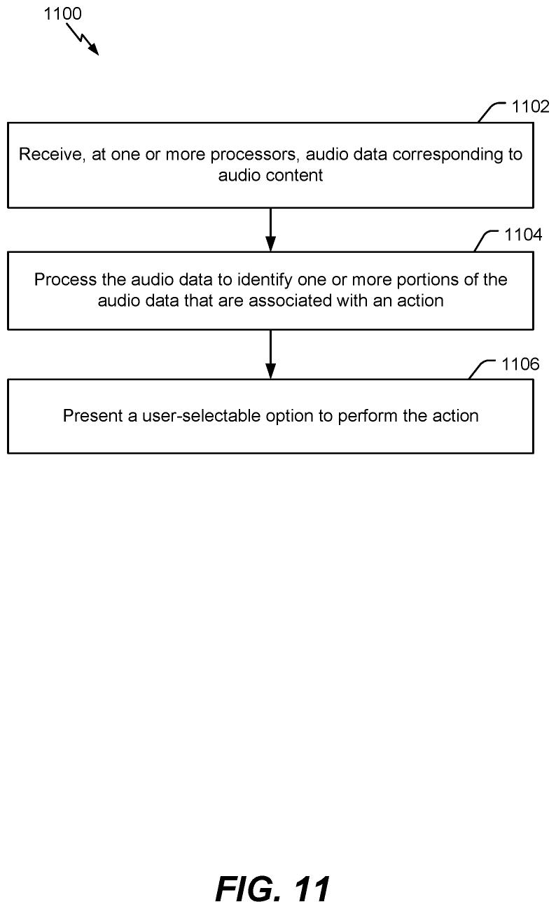

Referring to FIG. 11, a flowchart of a method 1100 of automatically proposing actions based on audio content is shown. In a particular aspect, one or more operations of the method 1100 can be performed by the action recommendation unit 130, the user interface controller 136, the action initiator 138, the processor 112, the device 110, the system 100 of FIG. 1, the content parser 202, the mapping unit 206, the list generator 208, the system 200 of FIG. 2, the system 300 of FIG. 3, the wearable device 600 of FIG. 6, the vehicle 700 of FIG. 7, the voice-controlled speaker system 800 of FIG. 8, the wearable electronic device 902 of FIG. 9, the device 1002 of FIG. 10, or a combination thereof.

The method 1100 includes receiving, at one or more processors, audio data corresponding to audio content, at 1102. For example, the action recommendation unit 130 of FIG. 1 receives the audio data 124 corresponding to the audio content 104, as described with reference to FIG. 1.

The method 1100 also includes processing the audio data to identify one or more portions of the audio data that are associated with an action, at 1104. For example, the action recommendation unit 130 of FIG. 1 processes the audio data 124 to identify the portions 126 of the audio data 124 that are associated with the actions 150, as described with reference to FIG. 1.

The method 1100 further includes presenting a user-selectable option to perform the action, at 1106. For example, the user interface controller 136 presents the user-selectable option 140 to perform the first action 151, as described with reference to FIG. 1.

In some implementations, the method 1100 includes generating a list of actions that correspond to the portions of the audio data that are identified over a particular time period, such as an event time period, a daily time period, a weekly time period, etc., as illustrated in FIG. 5. Upon expiration of the particular time period, a list of user-selectable options are presented to accept or decline performance of each of the actions, and in response to receiving a user input indicating that a particular action of the list is to be performed, the one or more framework calls or application programming interface (API) calls to perform the particular action are generated.

In some implementations, the audio data corresponds to at least one of a conversation or a phone call, and presenting the user-selectable option includes generating a graphical user interface (e.g., the GUI 142) that is presented in response to detection of an end of the conversation or the phone call. In some examples, presenting the user-selectable option further includes displaying, via the graphical user interface, a prompt that indicates the action and one or more user-selectable controls to accept or decline performance of the action.

According to some examples, presenting the user-selectable option to perform the action includes prompting a user whether to save contact information identified in the audio data, whether to set a reminder for an event identified in the audio data, whether to update a calendar for an appointment identified in the audio data, or any combination thereof, such as the call snapshot 530. In some examples, the audio data corresponds to a conversation with a medical professional, and presenting the user-selectable option to perform the action includes prompting a user whether to place an order for prescribed medication, whether to set alarms for a medication schedule, whether to set an alarm for a follow-up visit, whether to adjust a temperature at an environmental control unit, or any combination thereof, such as the medical snapshot 532. In some examples, the audio data corresponds to player conversations from a multi-player game, and presenting the user-selectable option to perform the action includes prompting a user whether to save a strategy of one of the players, whether to view a screen replay, whether to save the screen replay, whether to upload the screen replay to a social media account, or any combination thereof, such as the gaming snapshot 538. In some examples, the audio data corresponds to audio content captured by one or more microphones of a vehicle, and presenting the user-selectable option to perform the action includes prompting a user whether to initiate a phone call, whether to send a text message, whether to set a travel route, whether to update a meeting schedule, whether to notify emergency personnel, whether to save one or more addresses, whether to play a media selection, or any combination thereof, such as the vehicle snapshot 536.

The method 1100 thus enables action recommendations to be generated automatically based on the audio content 104. The first participant 102 can participate in the conversation 106 without having to pause to make notes. The auto-generated recommendations can assist in reminding the first participant 102 of details of the conversation 106.

FIG. 12 depicts a block diagram of a particular illustrative implementation of a device 1200 that includes the action recommendation unit 130, such as in a wireless communication device implementation (e.g., a smartphone) or a digital assistant device implementation. In various implementations, the device 1200 may have more or fewer components than illustrated in FIG. 12. In an illustrative implementation, the device 1200 may correspond to the device 110 of FIG. 1. In an illustrative implementation, the device 1200 may perform one or more operations described with reference to FIGS. 1-11.

In a particular implementation, the device 1200 includes a processor 1206 (e.g., a central processing unit (CPU) that corresponds to the processor 112 of FIG. 1) that includes the action recommendation unit 130. The device 1200 may include one or more additional processors 1210 (e.g., one or more DSPs). The processors 1210 may include a speech and music coder-decoder (CODEC) 1208. The speech and music codec 1208 may include a voice coder (“vocoder”) encoder 1236, a vocoder decoder 1238, or both.

The device 1200 may include a memory 1286 and a CODEC 1234. The memory 1286 may correspond to the memory 116 of FIG. 1 and may include instructions 1256 that are executable by the processor 1206 (or the one or more additional processors 1210) to implement the functionality described with reference to the action recommendation unit 130, the user interface controller 136, the action initiator 138 of FIG. 1, the content parser 202, the mapping unit 206, the list generator 208 of FIG. 2, or any combination thereof. The device 1200 may include a wireless controller 1240 coupled, via a transceiver 1250, to one or more antennas 1252. In some implementations, the one or more antennas 1252 include one or more antennas configured to receive at least a portion of audio data during a phone call.

The device 1200 may include a display 1228 (e.g., the display 120 of FIG. 1) coupled to a display controller 1226. The display 1228 may be configured to represent the GUI 142 of FIG. 1, the display data 240 of FIG. 2, or both. The CODEC 1234 may include a digital-to-analog converter (DAC) 1202 and an analog-to-digital converter (ADC) 1204. In a particular implementation, the CODEC 1234 may receive analog signals from one or more microphones 1212 (e.g., the microphone 114 configured to capture audio input that includes one or more keywords), convert the analog signals to digital signals using the analog-to-digital converter 1204, and provide the digital signals to the speech and music codec 1208. The speech and music codec 1208 may process the digital signals.

In a particular implementation, the speech and music codec 1208 may provide digital signals to the CODEC 1234 that represent an audio playback signal (e.g., indicating user-selectable options). The CODEC 1234 may convert the digital signals to analog signals using the digital-to-analog converter 1202 and may provide the analog signals to one or more loudspeakers 1214 to generate an audible signal. The one or more loudspeakers 1214 can correspond to at least one of the speaker 710 of FIG. 7 or the speaker 802 of FIG. 8.

In a particular implementation, the device 1200 includes one or more input devices 1230. The input device(s) 1230 can correspond to the camera 610 of FIG. 6. For example, the input device(s) 1230 can include one or more cameras configured to capture video content that includes one or more gestures or visual commands or that indicates gaze direction.

In a particular implementation, the device 1200 may be included in a system-in-package or system-on-chip device 1222. In a particular implementation, the memory 1286, the processor 1206, the processors 1210, the display controller 1226, the CODEC 1234, and the wireless controller 1240 are included in a system-in-package or system-on-chip device 1222. In a particular implementation, the input device(s) 1230 and a power supply 1244 are coupled to the system-in-package or system-on-chip device 1222. Moreover, in a particular implementation, as illustrated in FIG. 12, the display 1228, the input device 1230, the microphone 1212, the antenna 1252, and the power supply 1244 are external to the system-in-package or system-on-chip device 1222. In a particular implementation, each of the display 1228, the input device 1230, the microphone(s) 1212, the loudspeaker(s) 1214, the antenna 1252, and the power supply 1244 may be coupled to a component of the system-in-package or system-on-chip device 1222, such as an interface or a controller.

The device 1200 may include a mobile communication device, a smart phone, a cellular phone, a laptop computer, a computer, a tablet, a personal digital assistant, a display device, a television, a gaming console, a music player, a radio, a digital video player, a digital video disc (DVD) or Blu-ray disc player, a tuner, a camera, a navigation device, a virtual reality or augmented reality headset, a wearable electronic device, a vehicle console device, or any combination thereof, as illustrative, non-limiting examples.

In a particular implementation, one or more components of the systems and devices disclosed herein is integrated into a decoding system or apparatus (e.g., an electronic device, a CODEC, or a processor therein), into an encoding system or apparatus, or both. In other implementations, one or more components of the systems and devices disclosed herein may be integrated into a wireless telephone, a tablet computer, a desktop computer, a laptop computer, a set top box, a music player, a video player, an entertainment unit, a television, a game console, a navigation device, a communication device, a personal digital assistant (PDA), a fixed location data unit, a personal media player, a vehicle, a headset, a “smart speaker” device, or another type of device.

In conjunction with the described techniques, an apparatus includes means for receiving audio data at one or more processors. For example, the means for receiving may include the processor 112, the action recommendation unit 130, the processor 1206, the processors 1210, one or more other devices, circuits, modules, or any combination thereof.

The apparatus also includes means for processing the audio data to identify one or more portions of the audio data that are associated with an action. For example, the means for processing may include the processor 112, the action recommendation unit 130, the content parser 202, the mapping unit 206, the processor 1206, the processors 1210, one or more other devices, circuits, modules, or any combination thereof.

The apparatus also includes means for presenting a user-selectable option to perform the action. For example, the means for presenting may include the processor 112, user interface controller 136, the display 120, the processor 1206, the processor 1210, the display 1228, one or more other devices, circuits, modules, or any combination thereof.

It should be noted that various functions performed by the one or more components of the systems and devices disclosed herein are described as being performed by certain components or modules. This division of components and modules is for illustration only. In an alternate implementation, a function performed by a particular component or module may be divided amongst multiple components or modules. Moreover, in an alternate implementation, two or more components or modules may be integrated into a single component or module. Each component or module may be implemented using hardware (e.g., a field-programmable gate array (FPGA) device, an application-specific integrated circuit (ASIC), a DSP, a controller, etc.), software (e.g., instructions executable by a processor), or any combination thereof.

Those of skill would further appreciate that the various illustrative logical blocks, configurations, modules, circuits, and algorithm steps described in connection with the implementations disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). An exemplary memory device is coupled to the processor such that the processor can read information from, and write information to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

1. A device to automatically propose actions based on audio content, the device comprising:
a memory configured to store instructions corresponding to an action recommendation unit; and
one or more processors coupled to the memory, the one or more processors configured to:
receive audio data corresponding to the audio content; and
execute the action recommendation unit to:
process the audio data to identify, over a particular time period, one or more portions of the audio data that are associated with an action;
generate a list of the actions associated with the one or more portions of the audio data that are identified over the particular time period; and
upon expiration of the particular time period, present, via a graphical user interface, a list of prompts corresponding to the list of the actions, each prompt of the list of prompts indicating:
a proposed action to be performed;
a first user-selectable control to accept performance of the proposed action; and
a second user-selectable control to decline performance of the proposed action.

2. The device of claim 1, further comprising a display coupled to the one or more processors and configured to represent the graphical user interface.

3. The device of claim 2, wherein the audio data corresponds to at least one of a conversation or a phone call.

4. The device of claim 1, wherein the particular time period corresponds to a day, a week, a month, or a year, and wherein the one or more processors are further configured to:
in response to receiving a user input indicating that a particular proposed action of the list of prompts is to be performed, initiate performance of the particular proposed action.

5. The device of claim 2, wherein the display is further configured to present a third user-selectable control to activate automatic audio-based action recommendations.

6. The device of claim 1, wherein the one or more processors are configured to automatically execute the action recommendation unit in response to receiving the audio data.

7. The device of claim 1, wherein the one or more portions of the audio data correspond to one or more spoken keywords.

8. The device of claim 7, wherein the action recommendation unit includes:
a content parser configured to detect the one or more portions of the audio data; and
a mapping unit configured to map the one or more spoken keywords to actions.

9. The device of claim 8, wherein the mapping unit includes a database that associates actions with keywords.

10. The device of claim 8, wherein the mapping unit includes a machine learning unit.

11. The device of claim 1, wherein the one or more processors are further configured, in response to receiving a user input indicating that a particular proposed action of the list of prompts is to be performed, to generate one or more framework calls or application programming interface (API) calls to perform the particular proposed action.

12. The device of claim 1, wherein the audio data corresponds to at least one of a conversation or a phone call, and wherein the one or more processors are further configured to process the audio data and to generate a list of actions related to the conversation or the phone call to be proposed as the conversation or the phone call is ongoing.

13. The device of claim 1, further comprising one or more microphones configured to capture audio of at least a portion of a conversation or a phone call and to generate a microphone output corresponding to the audio data.

14. The device of claim 1, wherein the one or more processors are further configured to receive video content from one or more cameras and to determine, based on the video content, user gaze direction information to enable the action recommendation unit to attribute the one or more portions of the audio data to a particular participant of a conversation.

15. The device of claim 1, further comprising one or more antennas configured to receive at least a portion of the audio data during a phone call.

16. The device of claim 1, further comprising one or more loudspeakers configured to present the list of prompts via a speech interface.

17. The device of claim 1, wherein the one or more processors are incorporated into a virtual reality headset or augmented reality headset.

18. The device of claim 1, wherein the one or more processors are incorporated into a vehicle.

19. A method of automatically proposing actions based on audio content, the method comprising:
receiving, at one or more processors, audio data corresponding to the audio content;
processing the audio data to identify one or more portions of the audio data, over a articular time period, that are associated with an action;
generating a list of actions that correspond to the one or more portions of the audio data that are identified over the particular time period;
upon expiration of the particular time period, presenting a list of user-selectable options to accept or decline performance of each action of the list of actions; and
in response to receiving a user input indicating that a particular action of the list of actions is to be performed, initiating performance of the particular action.

20. The method of claim 19, wherein initiating performance of the particular action includes generating one or more framework calls or application programming interface (API) calls to perform the particular action.

21. The method of claim 19, wherein the particular time period corresponds to a day, a week, a month, or a year.

22. The method of claim 19, wherein presenting the list of user-selectable options further includes displaying a list of prompts via a graphical user interface, each prompt indicating:
a proposed action to be performed;
a first user-selectable control to accept performance of the proposed action; and
a second user-selectable control to decline performance of the proposed action.

23. The method of claim 19, wherein presenting the list of user-selectable options includes prompting a user whether to save contact information identified in the audio data, whether to set a reminder for an event identified in the audio data, whether to update a calendar for an appointment identified in the audio data, or any combination thereof.

24. The method of claim 19, wherein the audio content includes a conversation with a medical professional, and further comprising prompting a user whether to place an order for prescribed medication, whether to set alarms for a medication schedule, whether to set an alarm for a follow-up visit, whether to adjust a temperature at an environmental control unit, or any combination thereof.

25. The method of claim 19, wherein the audio content includes player conversations among players of a multi-player game, and further comprising prompting a user whether to save a strategy of one of the players, whether to view a screen replay, whether to save the screen replay, whether to upload the screen replay to a social media account, or any combination thereof.

26. The method of claim 19, wherein the audio data corresponds to audio content captured by one or more microphones of a vehicle, and further comprising prompting a user whether to initiate a phone call, whether to send a text message, whether to set a travel route, whether to update a meeting schedule, whether to notify emergency personnel, whether to save one or more addresses, whether to play a media selection, or any combination thereof.

27. A non-transitory computer readable medium storing instructions for automatically proposing actions based on audio content, the instructions, when executed by one or more processors, cause the one or more processors to:
receive audio data over a particular time period;
process the audio data to identify one or more portions of the audio data that are associated with an action;
generate a list of actions that correspond to the one or more portions of the audio data that are identified over the particular time period; and
upon expiration of the particular time period, present, via a graphical user interface, a list of prompts corresponding to the list of actions, each prompt of the list of prompts indicating:
a proposed action to be performed;
a first user-selectable control to accept performance of the proposed action; and
a second user-selectable control to decline performance of the proposed action.

28. The non-transitory computer readable medium of claim 27, wherein the instructions, when executed by the one or more processors, further cause the one or more processors, in response to receiving a user input indicating that a particular proposed action indicated by the list of prompts is to be performed, to generate one or more framework calls or application programming interface (API) calls to perform the particular proposed action.

29. An apparatus comprising:
means for receiving audio data at one or more processors over a particular time period;
means for processing the audio data to identify one or more portions of the audio data that are associated with an action;
means for generating a list of actions associated with the one or more portions of the audio data that are identified over the particular time period; and
means for presenting, via a graphical user interface, a list of prompts corresponding to the list of actions,
each prompt of the list of prompts indicating:
a proposed action to be performed;
a first user-selectable control to accept performance of the proposed action; and
a second user-selectable control to decline performance of the proposed action.

30. The apparatus of claim 29, further comprising means for capturing audio of at least a portion of a conversation or a phone call and for generating an output corresponding to the audio data.
